(19) United States
(12) Patent Application Publication
(10) Pub. No.: US 2010/0208902 A1
(43) Pub. Date: Aug. 19, 2010

(54) SOUND DETERMINATION DEVICE, SOUND DETERMINATION METHOD, AND SOUND DETERMINATION PROGRAM

(76) Inventors: Shinichi Yoshizawa, Osaka (JP); Yoshihisa Nakatoh, Kanagawa (JP)

Correspondence Address: WENDEROTH, LIND & PONACK L.L.P., 1030 15th Street, N.W., Suite 400 East, Washington, DC, 20005-1503, US

(21) Appl. No.: 12/770,971

(22) Filed: Apr. 30, 2010

Related U.S. Application Data
(63) Continuation of application No. PCT/JP2009/004849, filed on Sep. 25, 2009.

(30) Foreign Application Priority Data
Sep. 30, 2008 (JP) 2008-253106

(51) Int. Cl. H04R 29/00

(52) U.S. Cl. 381/56

(57) ABSTRACT

The noise removal device includes plural microphones, a time axis adjustment unit, an FFT analysis unit, and a noise removal processing unit, and determines frequency signals of a to-be-extracted sound by performing a threshold judgment on each of the phase distances, of the mixed sounds each received through a corresponding one of the microphones, in the case where the phases are expressed by the expression ψ′(t)=mod 2π(ψ(t)−2πft) (f denotes a reference frequency).

### CROSS REFERENCE TO RELATED APPLICATION

This is a continuation application of PCT application No. PCT/JP2009/004849 filed on Sep. 25, 2009, designating the United States of America.

### BACKGROUND OF THE INVENTION

(1) Field of the Invention

The present Invention relates to a sound determination device which determines frequency signals of to-be-extracted sounds included in a mixed sound on a per time-frequency domain basis, and in particular to a sound determination device and the like which determine frequency signals of to-be-extracted sounds in distinction from noises in the case where the to-be-extracted sounds and the noises are present in the same directions. In addition, the present invention also relates to a sound determination device which separates toned sounds such as an engine sound, a siren sound, and a voice, in distinction from toneless sounds such as a wind noise, a rain sound, and a background noise, and determines frequency signals of a toned sound (or a toneless sound) on a per time-frequency domain basis.

(2) Description of the Related Art

There are first conventional techniques intended to try to extract pitch cycles of an input audio signal (a mixed sound), and determine a sound having no pitch cycle to be a noise (For example, see Patent Reference 1: Japanese Unexamined Patent Application Publication No. 5-210397, (Claim 2, FIG. 1)). In the first conventional techniques, a voice s recognized based on an input voice determined to be a target voice.

FIG. 1 is a block diagram showing the structure of the first conventional technique disclosed in Patent Reference 1.

This conventional technique includes a recognition unit 2501, a pitch extraction unit 2502, a determination unit 2503, and a cycle range storage unit 2504.

The recognition unit 2501 is a processing unit which outputs a target voice to be recognized included in a signal segment estimated to be a voice portion (sound to be extracted) in an input audio signal (a mixed sound). The pitch extraction unit 2502 is a processing unit which extracts a pitch cycle from the input audio signal. The determination unit 2503 is a processing unit which outputs a result of voice recognition based on (i) the target sound to be recognized in the signal segment outputted by the recognition unit 2501 and (ii) the result of pitch extraction performed on the signal in the segment extracted by the pitch extraction unit 2502. The cycle range storage unit 2504 is a recording device which stores a cycle range corresponding to the pitch cycle to be extracted by the pitch extraction unit 2502. This conventional technique either determines a signal in the segment for recognition processing to be of a target voice when the pitch cycle is within a predetermined range, or determines a signal to be of a noise when the pitch cycle is outside the predetermined range.

There are second conventional techniques intended to finally determine the presence or absence of an input of a human voice based on the results of determinations made by first to third determination units (for example, see Patent Reference 2: Japanese Unexamined Patent Application Publication No. 2006-194959, Claim 1). The first determination unit determines that a human voice (sound to be extracted) is inputted when a signal component having a harmonic structure is detected from the input signal (mixed sound). The second determination unit determines that a human voice is inputted when the frequency center of gravity of the input signal is within a predetermined frequency range. The third determination unit determines that a human voice is inputted when the power ratio of the input signal with respect to a noise level stored in the noise level storage unit exceeds a predetermined threshold value.

There are third conventional techniques which receive sounds from sound sources present in plural directions, and calculate values each of which indicates probability that a sound source is present in a predetermined direction, based on the difference in phase components calculated for each frequency that is the same in all the directions. In addition, based on the probability values, the third conventional techniques suppress sound inputs from a sound source other than the sound source in the predetermined direction (for example, see Patent Reference 3: Japanese Unexamined Patent Application Publication No. 2007-318528, Claim 1).

FIG. 2 is a block diagram showing the structure of the third conventional technique disclosed in Patent Reference 3.

A directional sound reception device according to the conventional technique includes: a sound input unit 5100, a sound reception unit 5101, a signal conversion unit 5102, a phase difference calculation unit 5103, a probability value determination unit 5104, an inhibition function calculation unit 5105, an amplitude calculation unit 5106, a signal modification unit 5107, and a signal reconstruction unit 5108.

The sound reception unit 5101 receives mixed sounds from plural sound sources through two microphones (sound input units 5100). The signal conversion unit 5102 converts the input sounds into spectrum IN1 (f) and IN2 (f). Here, f denotes a frequency. The phase difference calculation unit 5103 calculates the phase spectra based on the spectrum IN1 (f) and IN2 (f), and calculates the difference between the phase spectra on a per frequency basis. The probability value determination unit 5104 determines probability values such that a higher probability value is set for the direction in which the sound source of a sound to be received is present. The inhibition function calculation unit 5105 calculates, on a per frequency basis, the inhibition function gain (f) based on the difference in the phase spectra and the probability values. The amplitude calculation unit 5106 calculates a representative value of an amplitude spectrum |IN1 (f)| of the spectrum of the input signal. The signal modification unit 5107 multiplies the amplitude spectrum |IN1 (f)| calculated by the amplitude calculation unit 5106 by the inhibition function gain (f) calculated by the inhibition function calculation unit 5105. The signal reconstruction unit 5108 converts a signal outputted from the signal modification unit 5107 into a signal on the time axis, and outputs the converted signal.

There are fourth conventional techniques that are coding methods of efficiently coding an audio signal with a determination that noises are dominant in a portion having a phase varying at random (for example, see Patent Reference 4: Japanese Unexamined Patent Application Publication No. 2002-515610, (Paragraph 0013)).

However, the first conventional technique is configured to extract pitch cycles on a per time segment basis, and thus it is impossible to determine, on a per time-frequency domain basis, a frequency signal of a to-be-extracted sound included in a mixed sound. In addition, it is impossible to determine a sound having a varying pitch cycle such as an engine sound (having a pitch cycle varying depending on the number of turns of the engine).

In addition, the second conventional technique is configured to determine a to-be-extracted sound, based on the spectrum shape such as the harmonic structure and the frequency center of gravity. For this, it is impossible to determine a to-be-extracted sound when the sound includes great noises causing distortion in the spectrum shape. In a particular case of a to-be-extracted sound having a spectrum shape distorted due to noises but is maintained when seen partially on a per time-frequency domain basis, it is impossible to determine that the frequency signal in the portion is a frequency signal of the to-be-extracted sound.

In addition, since the third conventional technique is configured to remove noises by receiving sounds with orientation in the predetermined direction, it is impossible to extract only sounds to be extracted in distinction from noises when the sounds to be extracted and the noises are present in the same direction.

In addition, since the fourth conventional technique is configured to code an audio signal, it is difficult to apply the configuration to a technique of extracting only a to-be-extracted sound from a mixed sound.

The present invention has been made to solve the aforementioned problems, and has an object to provide a sound determination device and the like which can determine a frequency signal of a to-be-extracted sound included in a mixed sound, on a per time-frequency domain basis. In particular, the present invention has an object to provide a sound determination device and the like which determine frequency signals of the to-be-extracted sounds in distinction from noises in the case where the to-be-extracted sounds and noises are present in the same directions. In addition, the present invention has an object to provide a sound determination device which separates toned sounds such as an engine sound, a siren sound, and a voice, in distinction from toneless sounds such as a wind noise, a rain sound, and a background noise, and determines frequency signals of a toned sound (or a toneless sound) on a per time-frequency domain basis.

### SUMMARY OF THE INVENTION

A sound determination device according to the present invention includes: a time axis adjustment unit configured to receive mixed sounds each of which includes a to-be-extracted sound and a noise through a corresponding one of a plurality of microphones, and adjust time axes of the mixed sounds such that a difference in arrival time points at which the mixed sounds from predetermined directions arrive at the plurality of respective microphones is zero; a frequency analysis unit configured to determine frequency signals of the mixed sounds, each of the frequency signals being at a corresponding one of predetermined time points in a predetermined time width on the time axes adjusted by the time axis adjustment unit; and a to-be-extracted sound determination unit configured to determine, for each of all the sounds to be extracted, frequency signals satisfying conditions of (i) being equal to or greater than a first threshold value in number and (ii) having a phase distance between the frequency signals that is equal to or smaller than a second threshold value, the condition-satisfying frequency signals being included in the frequency signals of the mixed sounds at the time points in the predetermined time width, and being determined by the frequency analysis unit, wherein the phase distance is a distance between phases of the condition-satisfying frequency signals when a phase of a frequency signal at a current time point t among the time points is ψ(t) (radian) and the phase ψ′(t) is expressed by an expression ψ′(t)=mod 2π(ψ(t)−2πft)=ψ(t), f denoting a reference frequency.

This configuration is intended to use a distance (an indicator for measuring a time shape of a phase ψ′(t) in a predetermined time width) according to the expression ψ′(t)=mod 2π(ψ(t)−2πft) (here, f denotes a reference frequency) when the phase of a frequency signal at a current time point t is ψ(t) (radian). This separates toned sounds such as an engine sound, a siren sound, and a voice in distinction from toneless sounds such as a wind noise, a rain sound, and a background sound, on a per time-frequency domain basis even when the to-be-extracted sounds and noises are present in the same direction. In addition, it is possible to determine frequency signals of a toned sound (or a toneless sound).

In mixed sounds each having a time axis adjusted with respect to the predetermined direction, the frequency signals of to-be-extracted sounds present in the predetermined direction have phase values similar between the frequency signals. For this reason, matching also the phase distances between the mixed sounds makes it possible to determine frequency signals of the to-be-extracted sounds more accurately than in the case of using a single mixed sound.

In addition, in the mixed sounds each having a time axis adjusted with respect to the predetermined direction, the frequency signals of to-be-extracted sounds present in a direction other than the predetermined direction have phase values different between the frequency signals. For this reason, it is possible to remove the sounds present in the direction other than the predetermined direction.

It is preferable that the aforementioned sound determination device further includes a noise determination unit configured to determine, from among the frequency signals determined by the frequency analysis unit, frequency signals, having a phase difference from all other frequency signals in the mixed sound that is equal to or greater than a third threshold value, each of the frequency signals being at a corresponding one of the predetermined time points on the time axes adjusted by the time axis adjustment unit, wherein the to-be-extracted sound determination unit is preferably configured to determine, to be frequency signals of the to-be-extracted sound, frequency signals satisfying the conditions of (i) being equal to or greater than the first threshold value in number and (ii) having the phase distance between the frequency signals that is equal to or smaller than the second threshold value, from among frequency signals obtained by subtracting the frequency signals determined by the noise determination unit from the frequency signals of the mixed sounds, the frequency signals being at the time points included in the predetermined time width, and being determined by the frequency analysis unit.

The sound determination device configured in this manner removes noises represented by the frequency signals having a phase difference between the mixed sounds received through microphones, that is equal to or greater than a third threshold value, and determines frequency signals of a to-be-extracted sound without the noises. Therefore, the sound determination device is capable of performing an accurate determination using the first threshold value, and performing an accurate determination of the to-be-extracted sound. For example, wind noises received through the respective microphones have different phases, and thus they can be removed based on the third threshold value. In addition, in the case of the sounds that are present in the direction other than the predetermined direction and received through the respective microphones, the frequency signals, at the microphones, which have phases adjusted in the time axes with respect to the predetermined direction have a great phase difference. Therefore, it is possible to remove noises using the third threshold value.

In addition, removing frequency signals, of the mixed sound, which yield a phase difference equal to or greater than the third threshold value from the frequency signals of all the other frequency signals in the mixed sounds makes it possible to determine frequency signals of the to-be-extracted sounds without removing the frequency signals which may represent the to-be-extracted sounds. For example, in the case where noises such as wind noises are received through one of the microphones independently, removing all the frequency signals other than the frequency signals having similar phase differences between all the microphones inevitably removes even a possible to-be-extracted sound received through the other microphone(s).

It is preferable that the time axis adjustment unit is configured to set plural directions as the predetermined directions, and adjust the time axes of the mixed sounds in each of the set directions, the frequency analysis unit is configured to determine frequency signals of the mixed sounds included in the predetermined time width on the time axes adjusted in each of the set directions, and that the to-be-extracted sound determination unit is configured to determine frequency signals of the to-be-extracted sound, from among the frequency signals of the mixed sounds, the frequency signals being included in the predetermined time width on the time axes adjusted in each of the set directions.

The sound determination device configured in this manner is capable of determining frequency signals of the to-be-extracted sound from the mixed sound, in plural directions. For this, even when the direction of the to-be-extracted sound is not known, it is possible to determine frequency signals of the to-be-extracted sound.

A sound detection device according to an aspect of the present invention includes: the aforementioned sound determination device; and a sound detection unit configured to generate and output a to-be-extracted sound detection flag when the sound determination device determines that a frequency signal among the frequency signals of the mixed sounds is a frequency signal of one of the sounds to be extracted.

The sound determination device configured in this manner is capable of detecting a to-be-extracted sound on a per time-frequency domain basis, and notifying a user of the detected sound. For example, a vehicle detection device having the sound determination device incorporated thereto is capable of detecting an engine sound as the to-be-extracted sound, and notifying a driver of the presence of an approaching vehicle.

A sound extraction device according to an aspect of the present invention includes: the aforementioned sound determination device; and a sound extraction unit configured to output a frequency signal among the frequency signals of the mixed sound when the sound determination device determines that the frequency signal is a frequency signal of one of the sounds to be extracted.

The sound extraction device configured in this manner uses frequency signals of the to-be-extracted sound determined on a per time-frequency domain basis, and thus, for example, an audio output device having the sound extraction device incorporated thereto is capable of reproducing a clear extracted sound from which noises have been removed. In addition, a sound source direction detection device having the sound extraction device incorporated thereto is capable of accurately calculating the sound source direction of the to-be-extracted sound from which noises have been removed. In addition, a sound recognition device having the sound extraction device incorporated thereto is capable of accurately identifying even a to-be-extracted sound surrounded by noises.

A direction detection device according to an aspect of the present invention includes: the aforementioned sound determination device; and a direction detection unit configured to output, to be a sound source direction, information indicating the predetermined direction in which frequency signals of the to-be-extracted sound are determined in one of the mixed sounds.

With this structure, even when to-be-extracted sounds are present in plural directions, the direction detection device determines, to be the sound source directions of the to-be-extracted sounds, the directions in which frequency signals of the respective to-be-extracted sounds are determined, and thus is capable of outputting information indicating the respective sound source directions of the to-be-extracted sounds. In particular, the direction detection device is capable of outputting the sound source directions of the respective to-be-extracted sounds even when different kinds of to-be-extracted sounds (for example, a voice of Person A and a voice of Person B) are inputted in different directions.

It is preferable that the direction detection device is configured to output, to be a sound source direction, information indicating a direction yielding a minimum phase distance, from among the predetermined directions in which the frequency signals of the to-be-extracted sound are determined in one of the mixed sounds.

The direction determination device configured in this manner outputs information indicating a direction that yields the minimum phase distances to be the sound source direction of the to-be-extracted sound, and thus is capable of accurately outputting the information indicating the sound source direction of the to-be-extracted sound inputted in a single direction.

It is to be noted that the present invention can be implemented not only as a sound determination device including such unique processing units as mentioned above, but also as a sound determination method having the steps corresponding to the unique processing units included in the sound determination device, and as a program causing a computer to execute the unique steps included in the sound determination method. As a matter of course, such program can be distributed through recording media such as CD-ROMs (Compact Disc-Read Only Memories) and via communication networks such as the Internet.

With a sound determination device and the like according to the present invention, it is possible to determine frequency signals of to-be-extracted sounds included in mixed sounds on a per time-frequency domain basis. In particular, the present invention allows determination of frequency signals of the to-be-extracted sounds in distinction from noises in the case where the to-be-extracted sounds and noises are present in the same direction. In addition, the present invention also allows separation of toned sounds such as an engine sound, a siren sound, and a voice, in distinction from toneless sounds such as a wind noise, a rain sound, and a background noise, and determination of frequency signals of a toned sound (or a toneless sound) on a per time-frequency domain basis.

For example, the present invention is applicable to: an audio output device which receives inputs of audio frequency signals determined on a per time-frequency domain basis, and outputs an extracted sound using inverse frequency transform; a sound source direction determination device which receives inputs of frequency signals of to-be-extracted sounds determined on a time-frequency basis from a mixed sound in each of directions, and outputs the sound source directions of the to-be-extracted sounds; a sound identification device which receives inputs of frequency signals of to-be-extracted sounds determined on a time-frequency basis, and performs voice recognition or sound identification; a vehicle detection device which detects an engine sound determined on a per time-frequency domain basis, and notifies a driver of the presence of an approaching vehicle; an emergency vehicle detection device which detects frequency signals of a siren sound determined on a per time-frequency domain basis, and notifies a driver of the presence of an approaching emergency vehicle; a vehicle detection device which notifies a driver of the direction in which an engine sound or a siren sound determined on a per time-frequency domain basis is present; and the like.

### FURTHER INFORMATION ABOUT TECHNICAL BACKGROUND TO THIS APPLICATION

The disclosure of Japanese Patent Application No. 2008-253106 filed on Sep. 30, 2008 including specification, drawings and claims is incorporated herein by reference in its entirety.

The disclosure of PCT application No. PCT/W2009/004849 filed on, Sep. 25, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing the overall structure of a conventional noise removal device;

FIG. 2 is a block diagram showing the overall structure of a conventional directional sound reception device;

Each of FIGS. 3A and 3B is a conceptual diagram illustrating a feature in the present invention;

FIG. 4 is an external view of a noise removal device according to Embodiment 1 of the present invention;

FIG. 5 is a block diagram showing the overall structure of the noise removal device according to Embodiment 1 of the present invention;

FIG. 6 is a block diagram showing a to-be-extracted sound determination unit 101(j) of the noise removal device according to Embodiment 1 of the present invention;

FIG. 7 is a flowchart indicating a procedure of operations performed by the noise removal device according to Embodiment 1 of the present invention;

FIG. 8 is a flowchart indicating Step S301(j) of determining each of frequency signals of a to-be-extracted sound; S301(j) is performed, as one of the operations in the procedure, by the noise removal device according to Embodiment 1 of the present invention;

FIG. 9 is a diagram showing an example of relationships between microphones and a sound arriving in a predetermined direction;

FIG. 10 is a diagram showing an example of mixed sounds received through microphones and having time axes adjusted to have a zero difference in arrival time points from the sound arriving in the predetermined direction;

FIG. 11 is an illustration of an exemplary method of selecting frequency signals;

Each of FIGS. 12A and 12B is another illustration of an exemplary method of selecting frequency signals;

FIG. 13 is a diagram illustrating an exemplary method of calculating a phase distance;

FIG. 14 is a schematic diagram showing the phases of frequency signals, of a mixed sound, in a time range (predetermined time width) used to calculate phase distances;

FIG. 15 is a diagram illustrating phase distances expressed by the expression ψ′(t)=mod 2π(ψ(t)−2πft) (here, f denotes a reference frequency);

FIG. 16 is a diagram illustrating a mechanism of temporally shifting a current phase counterclockwise;

FIG. 17 is a diagram illustrating phase distances expressed by the expression ψ′(t)=mod 2π(ψ(t)−2πft) (here, f denotes a reference frequency);

FIG. 18 is a diagram Illustrating an exemplary method of generating a histogram of phase components of frequency signals;

FIG. 19 is a diagram showing frequency signals selected by a frequency signal selection unit 200(j) and an exemplary histogram of phases of the selected frequency signals;

FIG. 20 is a block diagram showing the overall structure of a noise removal device according to Embodiment 2 of the present invention;

FIG. 21 is a block diagram showing a to-be-extracted sound determination unit 1502(j) of the noise removal device according to Embodiment 2 of the present invention;

FIG. 22 is a flowchart indicating a procedure of operations performed by the noise removal device according to Embodiment 2 of the present invention;

FIG. 23 is a flowchart indicating Step S1701(j) of determining each of frequency signals of a to-be-extracted sound; S1701(j) is performed, as one of the operations in the procedure, by the noise removal device according to Embodiment 2 of the present invention;

Each of FIG. 24 to FIG. 26 is a diagram illustrating an exemplary method of modifying phase differences due to time differences;

FIG. 27 is a diagram showing example of phases modified by the phase modification unit 1501(j);

FIG. 28 is a schematic diagram showing the phases of frequency signals, of a mixed sound, in a time range (predetermined time width) used to calculate phase distances;

FIG. 29 is a diagram schematically showing phases of mixed sounds in a predetermined time width;

FIG. 30 is a diagram illustrating an exemplary method of generating a histogram of phases of frequency signals;

FIG. 31 is a block diagram showing the overall structure of a vehicle detection device according to Embodiment 3 of the present invention;

FIG. 32 is a block diagram showing a to-be-extracted sound determination unit 4103(j) of the vehicle detection device according to Embodiment 3 of the present invention;

FIG. 33 is a flowchart indicating a procedure of operations performed by the vehicle detection device according to Embodiment 3 of the present invention;

FIG. 34 is a diagram showing an exemplary spectrogram of a mixed sound 2401(1) and a mixed sound 2401(2);

Each of FIG. 35 and FIG. 36 is a diagram illustrating a method of setting a suitable reference frequency f;

FIG. 37 is a diagram showing an example of a result of determining a frequency signal of an engine sound;

FIG. 38 is a block diagram showing the overall structure of a vehicle detection device according to Embodiment 3 of the present invention;

FIG. 39 is a flowchart showing a procedure of operations performed by a vehicle detection device 5500;

FIG. 40 is a diagram showing experimental results of detecting the direction in which a vehicle was approaching;

FIG. 41 is a diagram showing a first exemplary arrangement of plural microphones;

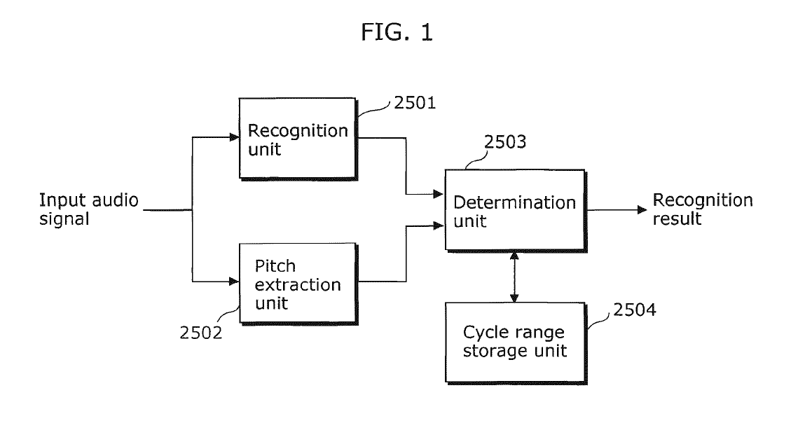

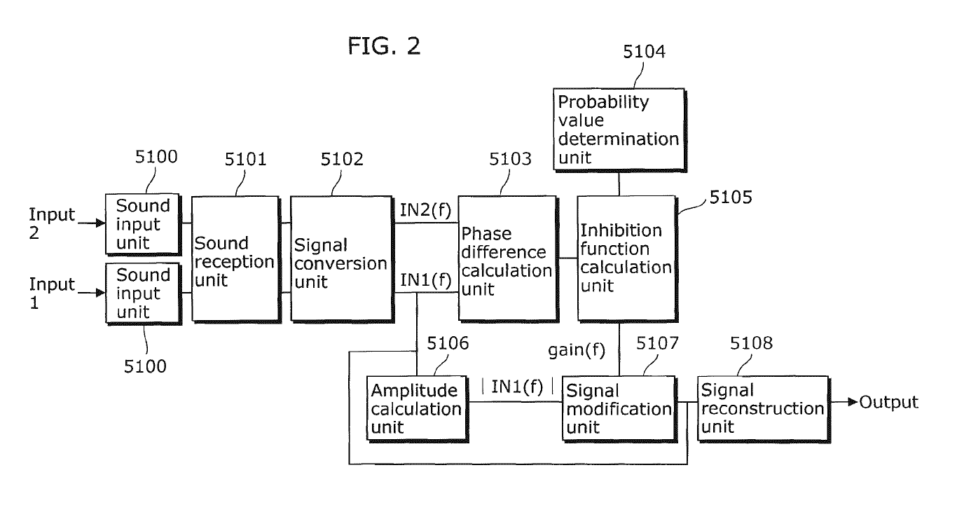

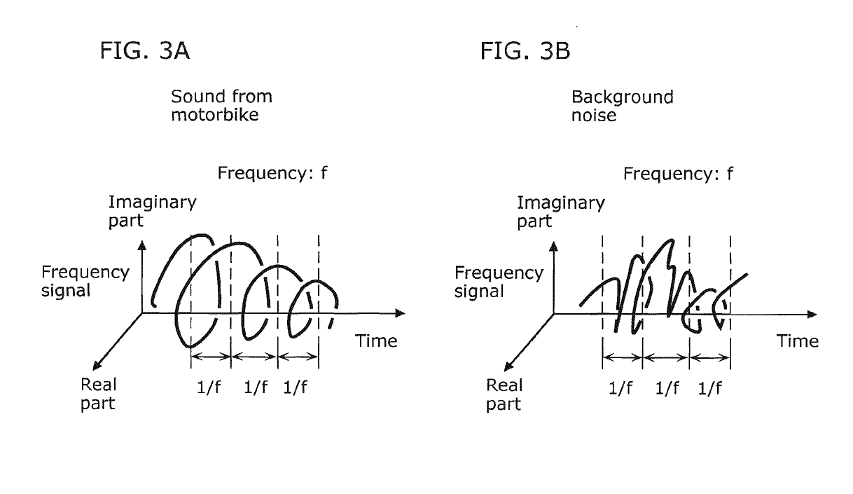

Each of FIG. 42 and FIG. 43 is a diagram showing a second exemplary arrangement of plural microphones; and

Each of FIG. 44 and FIG. 45 is a diagram showing a third exemplary arrangement of plural microphones.

### DESCRIPTION OF THE PREFERRED EMBODIMENT(S)

A feature of the present invention is to separate toned sounds such as an engine sound, a siren sound, and a voice in distinction from toneless sounds such as a wind noise, a rain sound, and a background noise, using frequency analysis of an input mixed sound made based on whether or not analysis-target frequency signals have a phase that temporally varies at a regular interval of 1/f (f denotes a reference frequency), and determine, for each of reference frequencies f, the frequency signals to be of a toned sound (or a toneless sound) on a per time-frequency domain basis.

Each of FIG. 3A and 3B is a conceptual diagram illustrating a feature in the present invention. FIG. 3A is a schematic diagram showing a result of frequency analysis of a motorbike sound (engine sound) performed using a frequency f. FIG. 3B is a schematic diagram showing a result of frequency analysis of a background noise performed using a frequency f. In each diagram, the horizontal axis is the time axis and the vertical axis is the frequency axis. As shown in FIG. 3A, a current phase of a frequency signal shifts at a regular time interval of 1/f (f denotes a reference frequency) and at an equal angle speed of 0 to 2π (radian) while the magnitude of the amplitude (power) of the frequency signal changes due to a temporal variation in frequency. For example, a current phase of a frequency signal of 100 Hz rotates by 2π (radian) in a 10-ms interval, and a current phase of a frequency signal of 200 Hz rotates by 2π (radian) in a 5-ms interval. In contrast, a frequency signal in a toneless sound such as a background noise has a phase that shifts irregularly with time. In addition, a portion distorted due to a mixed-in sound also has a phase that shifts irregularly with time. In this way, it is possible to determine, in a time-frequency domain, a frequency signal having a phase that shifts regularly with time. This makes it possible to determine frequency signals of a toned sound such as an engine sound, a siren sound, and a voice in distinction from toneless sounds such as a wind noise, a rain sound, and a background noise by determining, on a per time-frequency basis, frequency signals having a phase that shifts regularly with time.

Further, there is a difference in the degrees of regularity in the temporal phase variations between (i) a sound such as a siren sound that sounds mechanical and is similar to a sine wave and (ii) a sound such as a motorbike sound (engine sound) that is physically mechanical.

For this, the degrees of regularity in the temporal phase variations are represented using the following expression:

Sine wave>siren sound>motorbike sound (engine sound)>background noise [Expression 1]

Accordingly, the determination of the degrees of regularity in temporal phase variations is only a requirement for determining a frequency signal of a motorbike sound, from a mixed sound containing a siren sound, the motorbike sound, and a background noise.

In addition, in the present invention, the use of phase distances makes it possible to determine frequency signals of a to-be-extracted sound irrespective of the relationship between the frequency signal power of a noise and that of the to-be-extracted sound. For example, even in the case where the frequency signal power of a noise is great in a certain time-frequency domain, the use of this regularity in the phases makes it possible to determine frequency signals that represent the to-be-extracted sound and has, in a time-frequency domain, a power greater than that of the noise, and also determine even frequency signals that represent the to-be-extracted sound and has, in a time-frequency domain, a power smaller than that of the noise.

Hereinafter, embodiments of the present invention are described with reference to the drawings.

### Embodiment 1

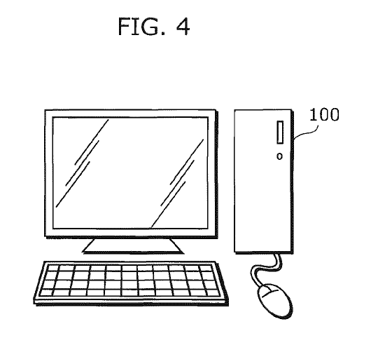

FIG. 4 is an external view of a noise removal device according to Embodiment 1 of the present invention. A noise removal device 100 includes a time axis adjustment unit, a frequency analysis unit, a to-be-extracted sound determination unit, and a sound extraction unit, and is configured as a CPU that is a component of a computer.

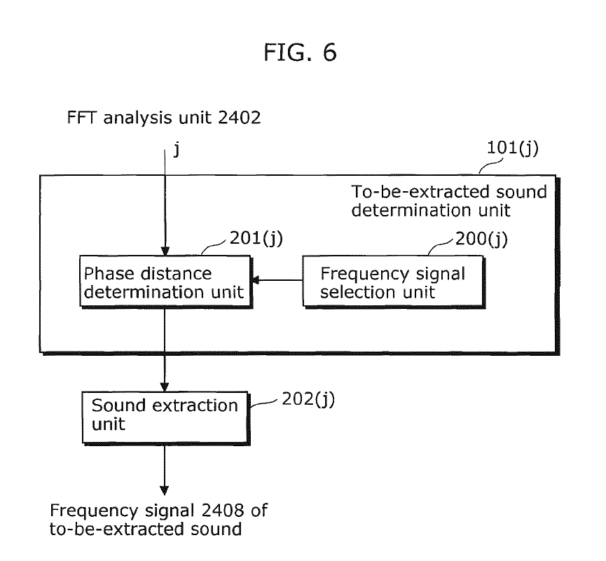

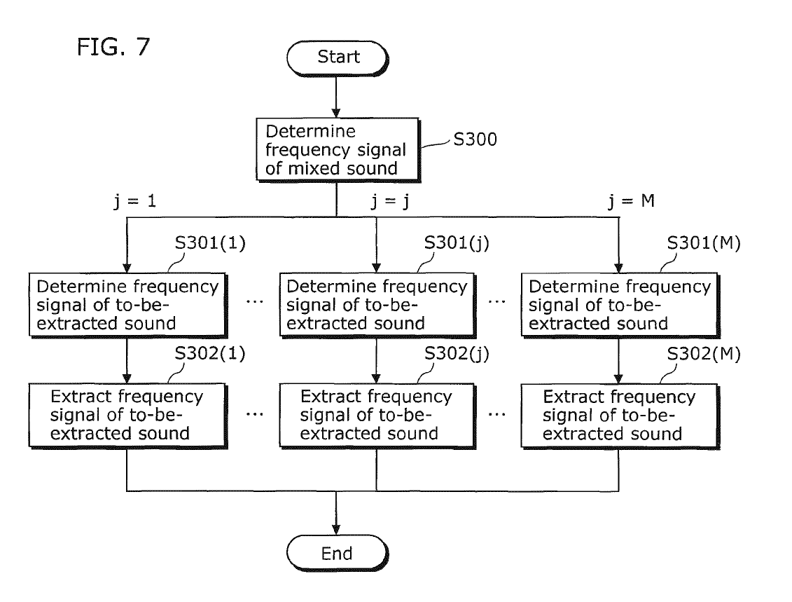

Each of FIG. 6 and FIG. 7 is a block diagram showing the structure of the noise removal device according to Embodiment 1 of the present invention.

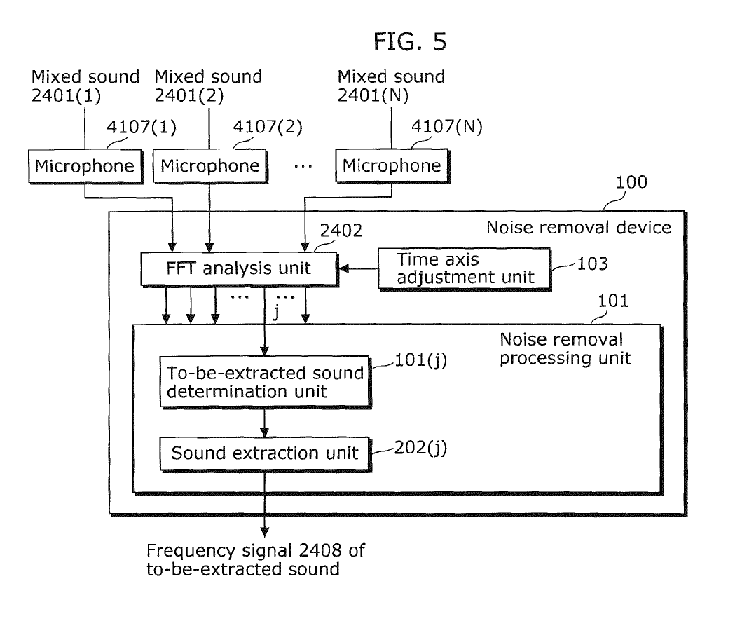

In FIG. 5, the noise removal device 100 includes a time axis adjustment unit 103, an FFT analysis unit 2402 (a frequency analysis unit), and a noise removal processing unit 101 (including a to-be-extracted sound determination unit and a sound extraction unit). The time axis adjustment unit 103, FFT analysis unit 2402, and noise removal processing unit 101 are operated by executing a program causing the computer to execute the functions of the respective processing units.

Plural microphones 4107(n) (n=1 to N) receive mixed sounds 2401(n) (n=1 to N).

The mixed sounds 2401(n) (n=1 to N) may be accumulated on a recording medium such as a DVD-ROM, and the following processing may be performed using the mixed sounds 2401(n) (n=1 to N) accumulated on the recording medium.

The FFT analysis unit 2402 receives the mixed sounds 2401(n) (n=1 to N), performs fast Fourier transform thereon, and determines frequency signals of the mixed sounds 2401(n) (n=1 to N) included in a predetermined time width on the time axes that the time axis adjustment unit 103 has adjusted such that the difference in the arrival time points at the respective microphones are zero with respect to the sound arriving in the predetermined direction. Hereinafter, it is assumed that the number of frequency bands of each of the frequency signals determined by the FFT analysis unit 2402 is denoted as M, and that the numbers specifying the respective frequency bands are denoted as j (j=1 to M).

At this time, the time axis adjustment unit 103 may adjust the time axes of the mixed sounds 2401(n) (n=1 to N) first, and next, may determine frequency signals using the mixed sounds 2401(n) (n=1 to N) included in the predetermined time width on the adjusted time axes. Alternatively, the processing order may be reversed, specifically, the FFT analysis unit 2402 may calculate frequency signals of the mixed sounds 2401(n) (n=1 to N) first, and then the time axis adjustment unit 103 may adjust the time axes of the mixed sounds 2401(n) (n=1 to N) included in the predetermined time width on the adjusted time axes, and select frequency signals of the mixed sounds 2401(n) (n=1 to N).

The noise removal processing unit 101 includes a to-be-extracted sound determination unit 101(j) (j=1 to M) and a sound extraction unit 202(j) (j=1 to M). The noise removal processing unit 101 is a processing unit that removes noises from the frequency signals determined by the FFT analysis unit 2402 by extracting the frequency signals of the to-be-extracted sound from the mixed sound, on a per frequency band j (j=1 to M) basis, using the to-be-extracted sound determination unit 101(j) (j=1 to M) and the sound extraction unit 202(j) (j=1 to M).

Using the frequency signals, of the mixed sounds 2401(n) (n=1 to N), at plural time points that are selected from among the time points at a 1/f (f denotes a reference frequency) time interval in the predetermined time width on the time axes adjusted by the time axis adjustment unit 103, the to-be-extracted sound determination unit 101(j) (j=1 to M) calculates phase distances between a frequency signal at a current time point for analysis and frequency signals at time points different from the current time point for analysis included in the predetermined time width. At this time, the number of frequency signals used to calculate phase distances is equal to or greater than a first threshold value. In addition, each of the phase distances is of the frequency signal when the phase of the frequency signal at a current time point t is ψ(t) (radian), and that the phase is represented using the expression ψ′(t)=mod 2π(ψ(t)−2πft) (here, f denotes a reference frequency). The frequency signals at the time points for analysis at which their phase distances are equal to or less than a second threshold value are determined to be frequency signals 2408 of the to-be-extracted sound.

At this time, it is also possible to determine the mixed sound 2401(n) (n=1 to N) from which a frequency signal of one of the to-be-extracted sounds is determined.

Lastly, the sound extraction unit 202(j) (j=1 to M) removes noises from the mixed sound by extracting the frequency signals 2408, of the to-be-extracted sound, determined by the to-be-extracted sound determination unit 101 (j) (j=1 to M).

Performing this processing at sequentially-shifted time points having a predetermined time width makes it possible to extract the frequency signals 2408 of the to-be-extracted sound on a per time-frequency domain basis.

FIG. 6 is a block diagram showing the structure of the to-be-extracted sound determination unit 101(j) (j=1 to M).

The to-be-extracted sound determination unit 101(j) (j=1 to M) includes a frequency signal selection unit 200(j) (j=1 to M) and a phase distance determination unit 201(j) (j=1 to M).

The frequency signal selection unit 200(j) (j=1 to M) is a processing unit that selects, as frequency signals to be used to calculate phase distances, frequency signals equal to or greater than the first threshold value in number from among the frequency signals, of the mixed sounds 2401(n) (n=1 to N), having a predetermined time width on the time axes adjusted by the time axis adjustment unit 103. The phase distance determination unit 201(j) (j=1 to M) is a processing unit that calculates the phase distances using the phases of the frequency signals, of the mixed sounds 2401(n) (n=1 to N), selected by the frequency signal selection unit 200(j) (j=1 to M), and determines the frequency signals that yield a phase distance equal to or less than the second threshold value to be frequency signals 2408 of the to-be-extracted sound.

Next, a description is given of operations performed by the noise removal device 100 configured as described above.

The following describes processing performed on a j-th frequency band. Here, a description is given of an exemplary case where the center frequency of the frequency band matches the reference frequency (frequency f according to the expression ψ′(t)=mod 2π(ψ(t)−2πft used to calculate the phase distance in determination on whether or not a to-be-extracted sound is present in the frequency f). Another method may be used to determine frequency signals of the to-be-extracted sound assuming that plural adjacent frequencies including the frequency band are the reference frequencies. In this case, it is possible to determine whether or not a to-be-extracted sound is present in the frequency around the center frequency.

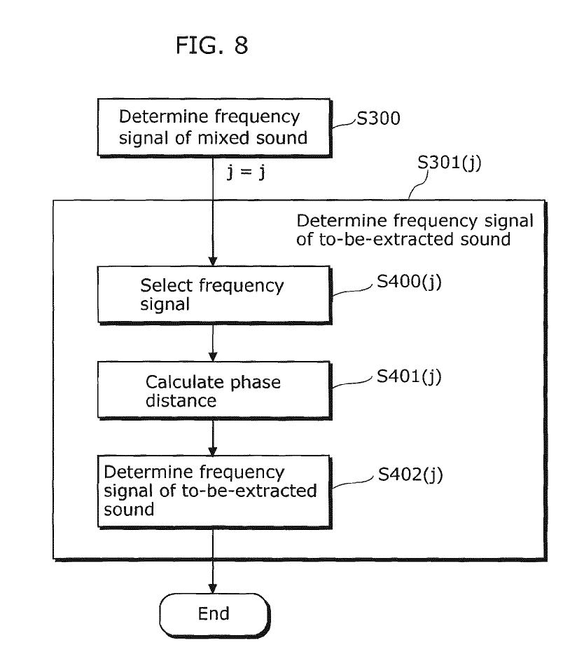

Each of FIGS. 7 and 8 is a flowchart showing a procedure of operations performed by a noise removal device 100.

Here, a description is given of taking an exemplary case of using, as the mixed sound 2401(n) (n=1 to N), a mixed sound including a voice A (voiced sound), a voice B (voiced sound), and a background noise. In this example, it is assumed that the sound sources of the sounds A and B are in different directions, and that the sound direction of the sound A is known. The object is to extract frequency signals of the voice A (toned sound) by removing the voice B and background noise from the mixed sounds 2401(n) (n=1 to N).

For example, it is possible to receive only the voices of a driver from among the voices heard in a car room, and use the voices, for example, as targets to be processed using a voice recognition function of a car navigation system that receives inputs of voice commands.

First, the FFT analysis unit 2402 receives the mixed sounds 2401(n) (n=1 to N), performs fast Fourier transform thereon, and determines frequency signals of the mixed sounds 2401(n) (n=1 to N) included in the predetermined time width on the time axes adjusted, by the time axis adjustment unit 103, such that the difference in the arrival time points at the respective microphones are zero with respect to the sound arriving in the direction of sound A (the predetermined direction) (Step S300). In this example, frequency signals are determined on a complex space using fast Fourier transform.

Here, a description is given of a method, performed by the time axis adjustment unit 103, of adjusting the time axes such that the difference in the arrival time points at the respective microphones is zero with respect to the sound arriving in the predetermined direction. Here, the predetermined direction is denoted as Θ.

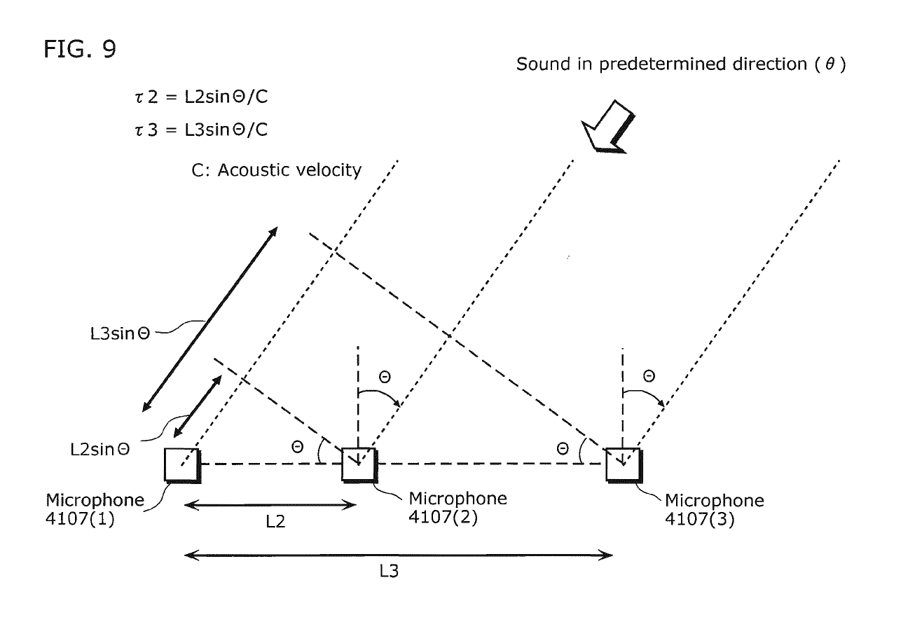

FIG. 9 is a diagram showing an example of relationships between the microphones 4107(n) (n=1 to N) and the sound arriving in the predetermined direction (Θ). In this example, the number of microphones is 3 (N=3). Here, when the distance between the microphone 4107(1) and the microphone 4107(2) is L2, and the distance between the microphone 4107(1) and the microphone 4107(3) is L3, the arrival time point difference τ2 between the microphone 4107(1) and the microphone 4107(2) and the arrival time point difference τ3 between the microphone 4107(1) and the microphone 4107(3) are calculated using the following expressions.

τ₂=L2 sin(θ)/C [Expression 2]

τ₃=L3 sin(θ)/C [Expression 3]

Here, C denotes an acoustic velocity.

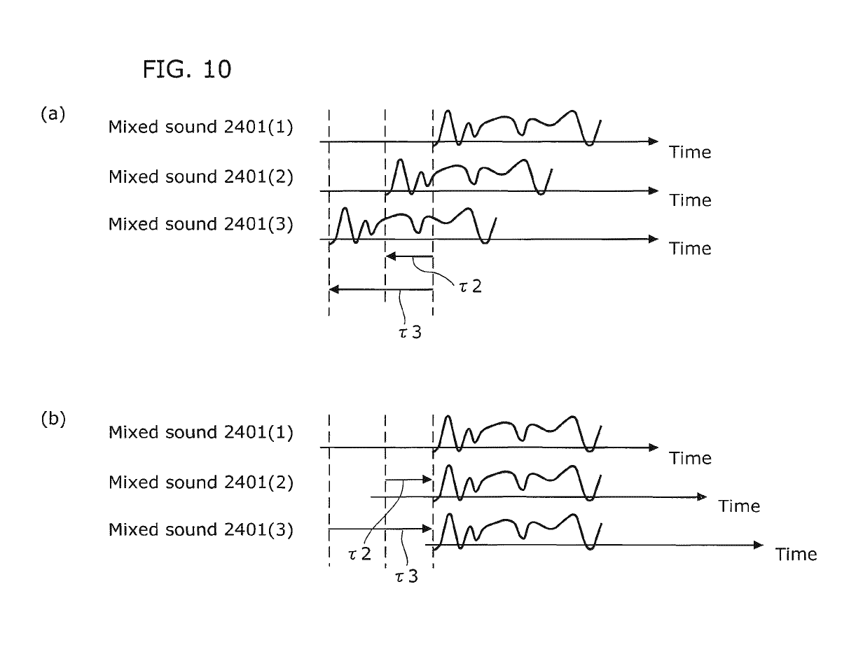

FIG. 10 is a diagram showing an example of mixed sounds received through microphones and having time axes adjusted to have a zero difference in arrival time points from the sound arriving in the predetermined direction. The horizontal axes represent the time axes. FIG. 10(a) shows the mixed sounds before the adjustment of the time axes, and FIG. 10(b) shows the mixed sounds after the adjustment in the time axes. As shown in FIG. 10(b), with reference to the mixed sound 2401 (1), it is possible to adjust the time axes such that the time points of the other mixed sounds match the time points of the sound arriving in the predetermined direction (Θ) by delaying the time axis of the mixed sound 2401(2) by τ2, and delaying the time axis of the mixed sound 2401(3) by τ3.

Next, for each of the frequency signals calculated by the FFT analysis unit 2402, the noise removal processing unit 101 causes, for each frequency band j, the to-be-extracted sound determination unit 101(j) to determine, on a per time-frequency domain basis, frequency signals of the to-be-extracted sounds from the mixed sounds (Step 5301(j)). Subsequently, the noise removal processing unit 101 removes noises by causing the sound extraction unit 202(j) to extract the frequency signals, of the to-be-extracted sound, determined by the to-be-extracted sound determination unit 101(j) (Step 5302(j)). The following description is given using the j-th frequency band only. In this example, the center frequency of the j-th frequency band is f.

The to-be-extracted sound determination unit 101(j) calculates phase distances between a frequency signal to be analyzed and all of the other frequency signals included in the predetermined time width (frequency signals of the mixed sounds 2401(n) (n=1 to N)), using the frequency signals in all the time points at a 1/f time interval within the predetermined time width (here, the value used as the first threshold value corresponds to 30 percent of the number of frequency signals at a 1/f time interval included within the predetermined time width). Subsequently, the to-be-extracted sound determination unit 101(j) determines, to be frequency signals 2408 of the to-be-extracted sound, the analysis-target frequency signals having a phase distance equal to or less than the second threshold value (Step S301(j)). Lastly, the sound extraction unit 202(j) removes noises by causing the to-be-extracted sound determination unit 101(j) to extract frequency signals of the to-be-extracted sound (Step S302(j)).

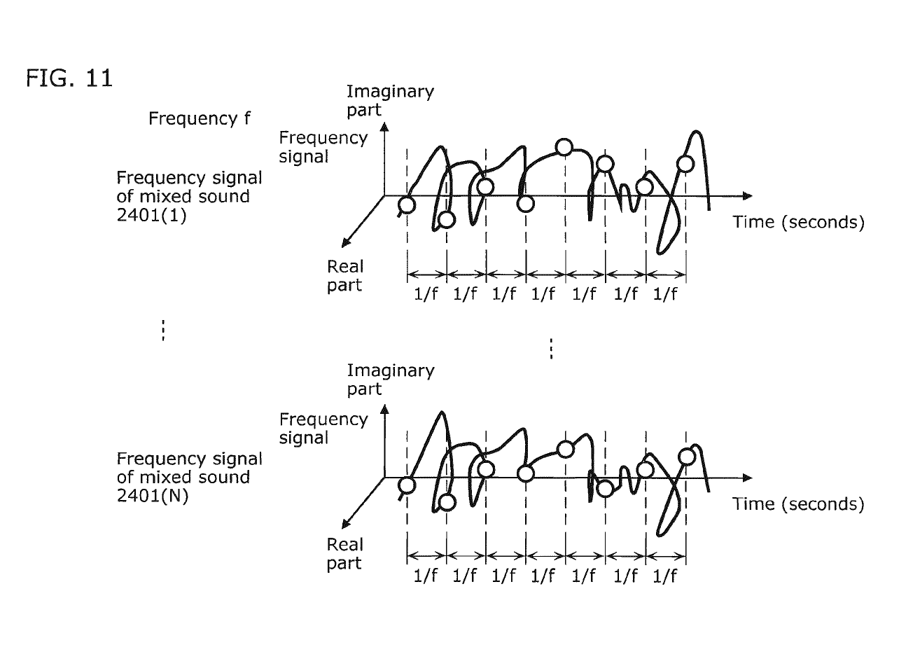

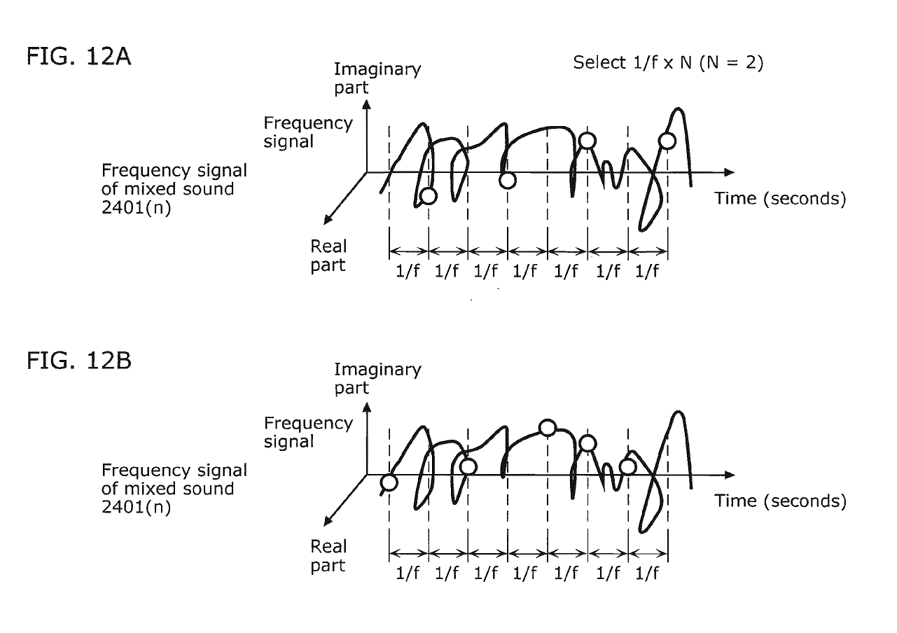

FIG. 11 schematically shows frequency signals of the mixed sounds 2401(n) (n=1 to N) at a frequency f. The horizontal axes represent time axes, and the two axes in vertical planes denote the real parts and the imaginary parts of the frequency signals. The time axes here have been adjusted toward the predetermined direction.

First, the frequency signal selection unit 200(j) selects, in number equal to or greater than the first threshold value, all frequency signals, of the mixed sounds 2401(n) (n=1 to N), having a 1/f time interval in a predetermined time width (Step 5400(j)). This threshold is placed because it is difficult to determine regularity of a temporal variation in phase when the number of frequency signals selected to calculate the phase distance is not sufficient. FIG. 11 shows, using open circles, the positions of frequency signals selected at a 1/f time interval.

Here, each of FIG. 12A and 12B shows another method of selecting frequency signals. The way of presentation is the same as in FIG. 11, and thus no description thereof is repeated. FIG. 12A shows an example of selecting frequency signals at time points at a time interval obtained according to an expression 1/f×N (N=2) from among the time points at a 1/f time interval. In addition, FIG. 12B shows an example of selecting frequency signals at time points selected at random from among the time points at a 1/f time interval. In other words, the method of selecting frequency signals may be any other methods of selecting frequency signals obtainable at time points at a 1/f time interval. It should be noted that the number of frequency signals to be selected needs to be equal to or greater than the first threshold value.

Here, the frequency signal selection unit 200(j) sets a time range (predetermined time width), of the frequency signal, which the phase distance determination unit 201(j) uses to calculate the phase distance. The method of setting the time range is described later together with a description given of the phase distance determination unit 201(j).

Next, the phase distance determination unit 201(j) calculates the phase distance, using all the frequency signals, of the mixes sounds 2401(n) (n=1 to N), selected by the frequency signal selection unit 200(j) (Step S401(j)). The phase distance used here is an inverse of a cross-correlation value between frequency signals normalized by signal power.

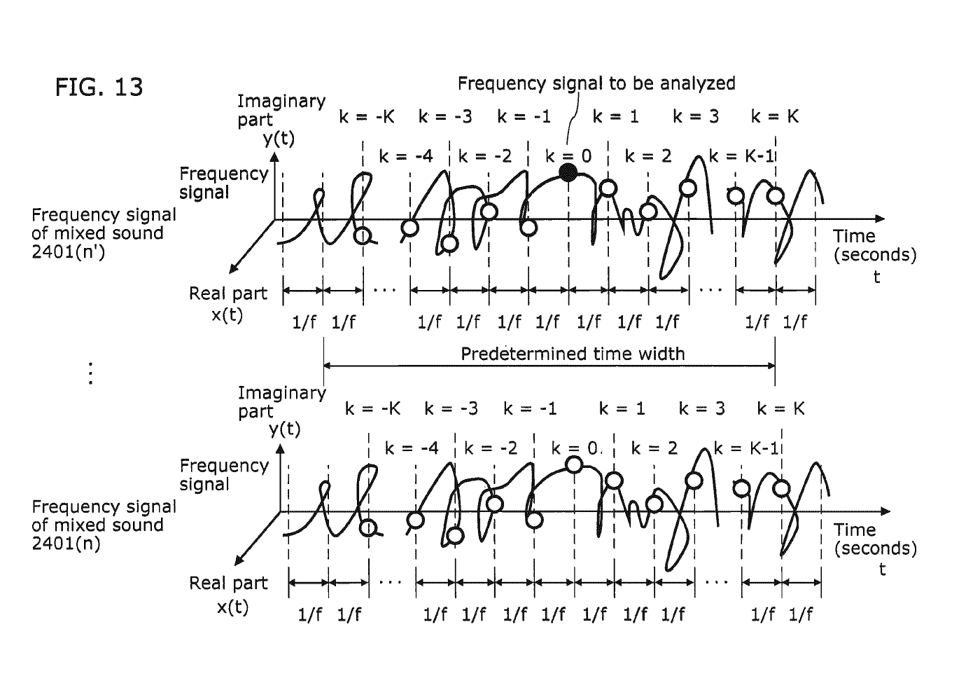

FIG. 13 shows an example of how to calculate a phase distance. With regard to the presentation in FIG. 13, the same description given of FIG. 11 is not repeated. In FIG. 13, a filled circle denotes a frequency signal at a current time point for analysis. The time length corresponding to the predetermined time width used here is preferably set to be within 2 to 4 times the time window width of the window function in the fast Fourier transform performed by the FFT analysis unit 2402.

Here, the method of calculating the phase distance is described below. In this example, the frequency signals of a 1/f time interval are used to calculate phase distances.

The following represents the real part of a frequency signal in a mixed sound 2401(n) (n=1 to N).

xₙₖ(n=1, . . . , N) (k=−K, . . . ,−2,−1,0,1,2, . . . , K) [Expression 4]

The following represents the imaginary part of a frequency signal in a mixed sound 2401(n) (n=1 to N).

yₙₖ(n=1, . . . , N) (k=−K, . . . ,−2,−1,0,1,2 . . . , K) [Expression 5]

Here, symbols n and k are numbers specifying the frequency signals. The frequency signals represented as n=n′ and k=0 are the frequency signal to be analyzed.

Here, in order to calculate a phase distance, the frequency signals normalized by signal power are calculated.

The following represents the value obtained by normalizing the real part of a frequency signal using signal power.

$${x}_{nk}^{′} = \frac{{x}_{nk}}{\sqrt{{( {x}_{nk} )}^{2} + {( {y}_{nk} )}^{2}}} \\ ( n = 1 , … , N ) \\ ( k = - K , … , - 2 , - 1 , 0 , 1 , 2 , … , K ) \qquad [ Expression 6 ]$$

The following represents the value obtained by normalizing the real part of the frequency signal using signal power.

$${y}_{nk}^{′} = \frac{{y}_{nk}}{\sqrt{{( {x}_{nk} )}^{2} + {( {y}_{nk} )}^{2}}} \\ ( n = 1 , … , N ) \\ ( k = - K , … , - 2 , - 1 , 0 , 1 , 2 , … , K ) \qquad [ Expression 7 ]$$

The phase distance S is calculated using the following.

S=1/(Σₙ₌₁^{n=N}Σ_{k=-K}^{k=K}(x′_{n′0}×x′ₙₖ+y′_{n′0}×y′ₙₖ)+α) [Expression 8]

Here, the phase of the frequency signal has a 1/f time interval and is expressed by the expression ψ′(t)=mod 2π(ψ(t)−2πft)=ψ(t), and thus it is possible to calculate the phase distance using the frequency signal directly.

Other methods of calculating phase distances S are indicated below.

One is a method using normalization by the total number of frequency signals in a cross-correlation calculation according to the following expression.

S=1/1/(2K+1)N(Σₙ₌₁^{n=N}Σ_{k=-K}^{k=K}(x′_{n′0}×x′ₙₖ+y′_{n′0}×y′ₙₖ)+α) [Expression 9]

Another is a method using a difference error of a frequency signal according to the following expression.

S=1/(2K+1)NΣₙ₌₁^{n=N}Σ_{k=-K}^{k=K}\sqrt{(x′_{n′0}−x′ₙₖ)²+(y′_{n′0}−y′ₙₖ)²} [Expression 10]

Another is a method using a difference error of a phase according to the following expression.

S=1/(2K+1)NΣₙ₌₁^{n=NΣ}_{k=-K}^{k=K}|mod 2π(arctan(y_{n′0}/x_{n′0}))−mod 2π(arctan(yₙₖ/xₙₖ))| [Expression 11]

Another is a method using a value of phase variance. These methods involve methods of removing phase distances between frequency signals to be analyzed. In the mixed sound 2401(n) (n=1 to N), the phase ψ′ of the frequency signal having a 1/f time interval is expressed by the expression ψ′(t)=mod 2π(ψ(t)−2πft)=ψ(t), and thus the phase distance can be calculated according to the simple expression using ψ(t).

Here, α in Expressions 8 to 9 is a small value predetermined in order to prevent infinite divergence of S.

α [Expression 12]

It is also good to calculate a phase distance considering that the phase values are in a torus (that is, 0 (radian) and 2π (radian) are the same).

For example, in the case of calculating a phase distance using the phase difference error shown in Expression 11, it is also good to calculate a phase distance using the following right term.

|mod 2π(arctan(y_{n′0}/x_{n′0}))−mod 2π(arctan(yₙₖ/xₙₖ))|≡min{|mod 2π(arctan(y_{n′0/x}_{n′0}))−mod 2π(arctan(yₙₖ/xₙₖ))|,

|mod 2π(arctan(y_{n′0}/x_{n′0}))−(mod 2π(arctan(yₙₖ/xₙₖ))+2π)|,

|mod 2π(arctan(y_{n′0}/x_{n′0}))−(mod 2π(arctan(yₙₖ/xₙₖ))−2π)|} [Expression 13]

Next, the phase distance determination unit 201(j) determines, to be a frequency signal 2408 of the to-be-extracted sound (voice A), each of the analysis-target frequency signals (of the mixed sounds 2401(n) (n=1 to N)) having a phase distance equal to or less than the second threshold value (Step 5402(j)).

These processes are performed on all the analysis-target frequency signals at the time points calculated with time shifts in the time axis direction.

Lastly, the sound extraction unit 202(j) removes noises by causing its to-be-extracted sound determination unit 101(j) to extract the frequency signals determined to be frequency signals 2408 of the to-be-extracted sound.

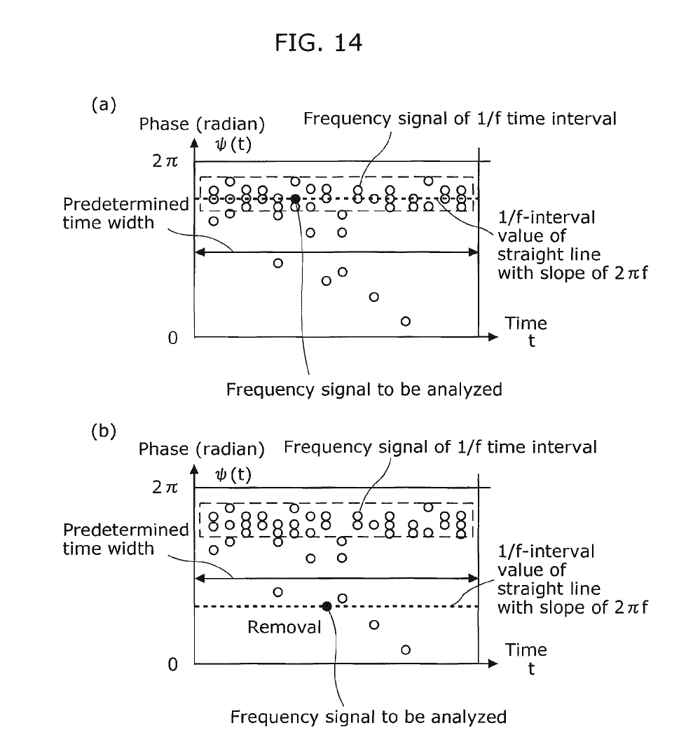

Here, a consideration is given of the phase of a frequency signal to be removed as a noise. Here, the second threshold value is set to π/2 (radian). FIG. 14 is a schematic diagram showing the phases of frequency signals, of the mixed sound, in a predetermined time width used to calculate phase distances. The horizontal axis is the time axis, and the vertical axis is the phase axis. Each of the filled circles shows a current phase of the analysis-target frequency signal. Here, the phases of the frequency signals are shown at a 1/f time interval. As shown in FIG. 14(a), calculating a phase distance at ψ′(t) according to the expression ψ′(t)=mod 2π(ψ(t)−2πft) (here, f denotes a reference frequency) is equivalent to calculating a distance, at ψ(t), from a straight line that passes through the phase ψ(t) of the analysis-target frequency signal with a slope of 2πf with respect to time t (the straight line having a 1/f time interval is horizontal with respect to the time axis). In FIG. 14(a), the phases of the frequency signals are present near this straight line. Therefore, the phase distances with the frequency signals in number equal to or greater than the first threshold value are equal to or less than the second threshold value, and the analysis-target frequency signal is determined to be of a frequency signal of the to-be-extracted sound. In addition, as shown in FIG. 14(b), when there is almost no frequency signals near the straight line that passes through the analysis-target frequency signal with a slope of 2πf with respect to time, the phase distances with the frequency signals in number equal to or greater than the first threshold value are greater than the second threshold value, and the analysis-target frequency signal is removed as a noise without being determined to be a frequency signal of the to-be-extracted sound.

At this time, the frequency signals of a voice A (toned sound) are present in the predetermined direction, and thus have a similar phase according to ψ′(t)=mod 2π(ψ(t)−2πft)=ψ(t) because the time axes of the mixed sounds 2401(n) (n=1 to N) have been adjusted to the direction of the voice A. Based on this, the frequency signals of the voice A are extracted.

In addition, the frequency signals of a voice B (toned sound) are present in a direction other than the predetermined direction, and thus have a discrete phase according to ψ′(t)=mod 2π(ψ(t)−2πft)=ψ(t) because the time axes of the mixed sounds 2401(n) (n=1 to N) have not been adjusted to the direction of the voice B. Based on this, the frequency signals of the voice B are extracted.

In addition, frequency signals of a background noise (toneless sound) have a discrete value according to ψ′(t)=mod 2π(ψ(t)−2πft)=ψ(t), and thus can be removed.

With this structure, even when the to-be-extracted sounds and noises are present in the same direction, it is possible to separate toned sounds such as an engine sound, a siren sound, and a voice in distinction from toneless sounds such as a wind noise, a rain sound, and a background noise on a per time-frequency domain basis, using the phase distances ψ′(t) according to the expression ψ′(t)=mod 2π(ψ(t)−2πft) (here, f denotes a reference frequency) when the phase of the frequency signal at the current time point t is ψ(t) (radian). In addition, it is possible to determine frequency signals of a toned sound (or a toneless sound).

In mixed sounds each having a time axis adjusted with respect to the predetermined direction, the frequency signals of to-be-extracted sounds present in the predetermined direction have similar phase values. For this reason, matching also the phase distances between the mixed sounds makes it possible to determine frequency signals of the to-be-extracted sounds more accurately than in the case of using a single mixed sound.

In addition, in the mixed sounds each having a time axis adjusted with respect to the predetermined direction, each of the frequency signals of to-be-extracted sounds present in a direction other than the predetermined direction has a different phase value. For this reason, it is possible to remove the sounds present in the direction other than the predetermined direction.

In addition, the phase distance of a frequency signal at a 1/f time interval can be easily calculated using the expression ψ′(t)=mod 2π(ψ(t)−2πft)=ψ(t) (here, f denotes a reference frequency).

Here, a description is given of a phase distance according to the expression ψ′(t)=mod 2π(ψ(t)−2πft)=ψ(t) (here, f denotes a reference frequency). As described with reference to FIG. 3A, the frequency signal (having frequency components) of a toned sound has a regular equal angle speed in a predetermined time width and rotates by 2π (radian) at a 1/f time interval.

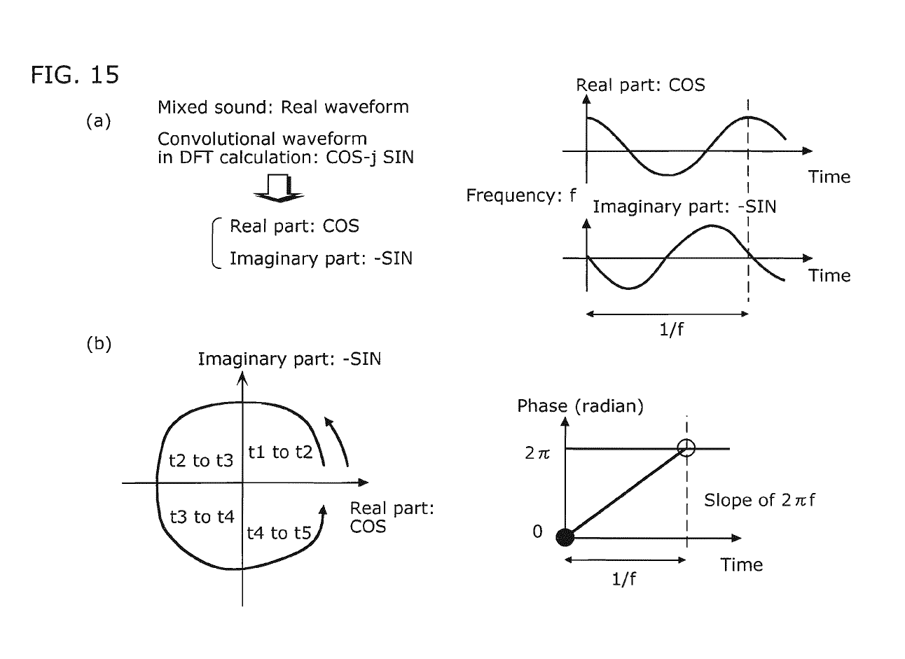

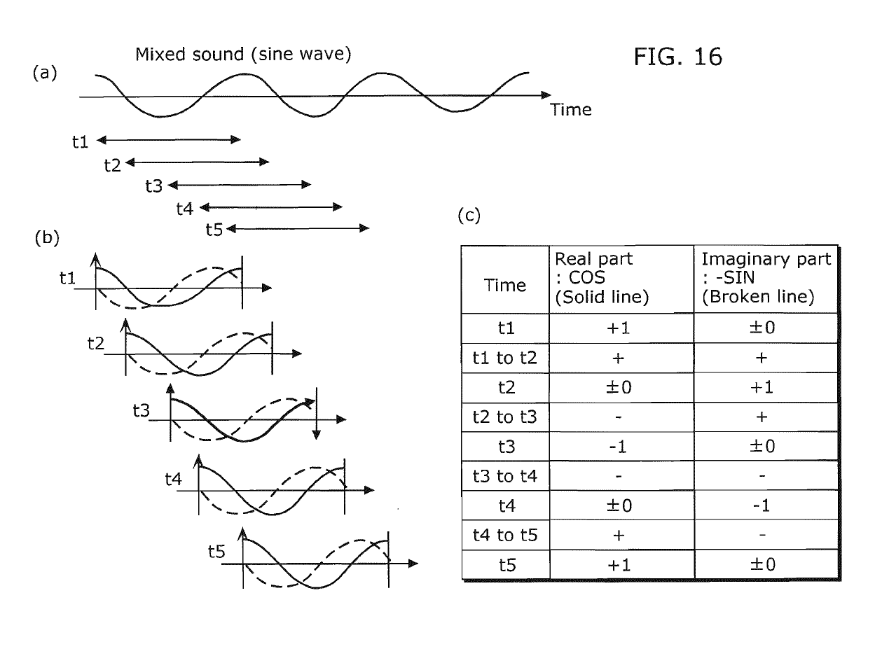

FIG. 15(a) shows the waveform of a signal to be convoluted into the to-be-extracted sound in DFT (Discrete Fourier Transform) calculation. The real part is a cosine waveform, and the imaginary part is a negative sine waveform. Here, a signal of a frequency f is analyzed. In the case where the to-be-extracted sound is a sine wave of a frequency f, analysis shows that the frequency signal has a phase ψ(t) that shifts with time counterclockwise as shown in FIG. 15(b). At this time, the horizontal axis represents the real part, and the vertical axis represents the imaginary part. Assuming that the counterclockwise direction is the positive direction, the phase ψ(t) increments by 2π (radian) at a 1/f time interval. In other words, the phase ψ(t) shifts with a slope of 2πf with respect to time t. With reference to FIG. 16, a description is given of a mechanism of shifting a current phase ψ(t) with time counterclockwise. FIG. 16(a) shows a to-be-extracted sound (that is a sine wave having a frequency f). Here, the magnitude (power) of the amplitude of the to-be-extracted sound is normalized to 1. FIG. 16(b) shows the DFT waveform (of a frequency f) of a signal to be convoluted into the to-be-extracted sound in frequency analysis. The solid line shows the cosine waveform as the real part, and the broken line shows the negative sine wave as the imaginary part. FIG. 16(c) shows the codes corresponding to the values obtained in the convolution of the DFT waveform shown in FIG. 16(b) into the to-be-extracted sound shown in FIG. 16(a). FIG. 16(c) shows that the current phase shifts: to the first quadrant in FIG. 15(b) when the current time point shifts from t1 to t2; to the second quadrant in FIG. 15(b) when the current time point shifts from t2 to t3; to the third quadrant in FIG. 15(b) when the current time point shifts from t3 to t4; and to the fourth quadrant in FIG. 15(b) when the current time point shifts from t4 to t5. This shows that the current phase ψ(t) shifts with time counterclockwise.

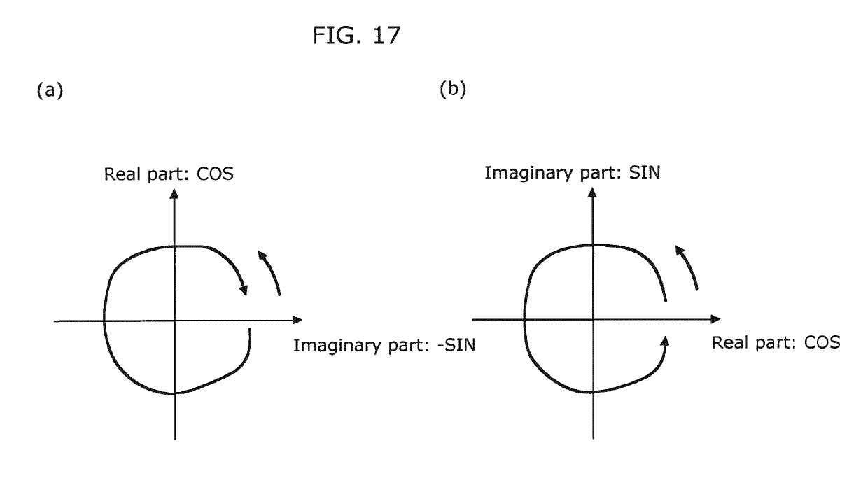

As supplemental information, FIG. 17(a) shows that the current phase ψ(t) inversely shifts with a slope of −2πf with respect to time t when the horizontal axis is the imaginary part and the vertical axis is the real part. Here, a description is given assuming that the phases are modified to match the axes in FIG. 15(b). In addition, as shown in FIG. 17(b), the current phase ψ(t) inversely shifts with a slope of −2πf with respect to time t when the real part is a cosine waveform and the imaginary part is a sine waveform while the current phase ψ(t) decrements by −2πf (radian) at a 1/f time interval when the counterclockwise direction is the positive direction. Here, a description is given assuming that the codes of the real and imaginary parts are modified to match the frequency analysis results in FIG. 15(a).

This shows that the phase ψ(t) of a frequency signal of a toned sound shifts with a slope of 2πf with respect to time t, resulting in a small phase distance at a phase ψ′(t) according to the expression ψ′(t)=mod 2π(ψ(t)−2πft) (here, f denotes a reference frequency).

### Variation 1 of Embodiment 1

Next, a description is given of a variation of the noise removal device shown in Embodiment 1.

The noise removal device according to this variation has a structure similar to the structure of the noise removal device according to Embodiment 1 described with reference to FIGS. 5 and 6. The difference lies in the processing performed by the noise removal processing unit 101.

The phase distance determination unit 201(j) in the to-be-extracted sound determination unit 101(j) generates a phase histogram using frequency signals, at time points at a 1/f time interval, selected by the frequency signal selection unit 200(j), determines, based on the histogram, the frequency signals that satisfy the conditions of (i) having a phase distance equal to or less than a second threshold value, and (ii) having the number of times of appearance equal to or greater than a first threshold value, and determines the frequency signals to be frequency signals 2408 of a to-be-extracted sound.

Lastly, the sound extraction unit 202(j) removes noises by extracting the frequency signals 2408 of the to-be-extracted sound having the phase distances determined by the phase distance determination unit 201(j).

Next, a description is given of operations performed by the noise removal device 100 configured as described above. Similarly to the flowcharts in Embodiment 1, FIGS. 7 and 8 are flowcharts indicating a procedure of operations performed by the noise removal device 100.

For the frequency signal determined by the FFT analysis unit 2402 (frequency analysis unit), the noise removal processing unit 101 determines the frequency signals of the to-be-extracted sound, using the to-be-extracted sound determination unit 101(j) (j=1 to M) on a per frequency band j (j=1 to M) basis (Step S301(j) (j=1 to M)). The following description is given using the j-th frequency band only. In this example, the center frequency of the j-th frequency band is f.

The to-be-extracted sound determination unit 101(j) generates a phase histogram, using frequency signals, of mixed sounds 2401(n) (n=1 to N) at time points at a 1/f time interval, selected by the frequency signal selection unit 200(j). The frequency signals satisfying the conditions of having (i) the phase distance equal to or less than the second threshold value and (ii) the number of times of appearance equal to or greater than the first threshold value are determined to be frequency signals 2408 of the to-be-extracted sound (Step 5301(j)).

The phase distance determination unit 201(j) generates the phase histogram of the frequency signals selected by the frequency signal selection unit 200(j), and determines the phase distance (Step S401(j)). A method of generating such histogram is described below.

Each of the frequency signals selected by the frequency signal selection unit 200(j) is expressed by Expressions 4 and 5. Here, the phase of the frequency signal is calculated using the following Expression.

φₙₖ=arctan(yₙₖ/xₙₖ) (n=1, . . . , N) (k=−K, . . . ,−2,−1,0,1,2, . . . , K) [Expression 14]

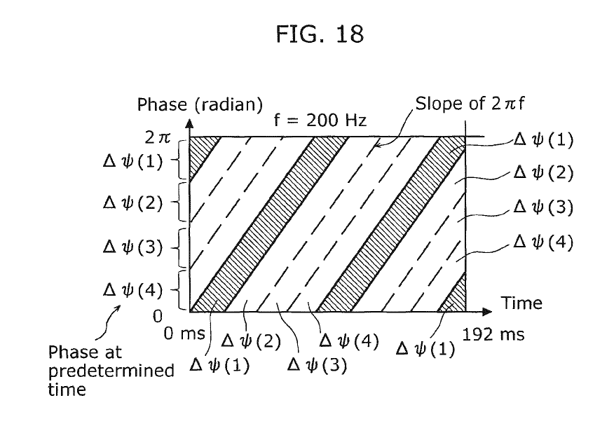

FIG. 18 shows an exemplary method of generating a histogram of the phases of frequency signals. Here, the histogram is generated by calculating the number of times of appearance of each frequency signal in a predetermined time width, for each band in a phase segment represented as Δψ(i) (i=1 to 4) that varies with a slope of 2πf (f denotes a reference frequency) with respect to time. The shaded portions in FIG. 18 are regions of Δψ(1). Here, the phases are represented within a limited range of 0 to 2π (radian), and thus the regions are discrete. Here, it is possible to generate the histogram by counting the number of frequency signals included in each of the regions represented as Δψ(i) (i=1 to 4).

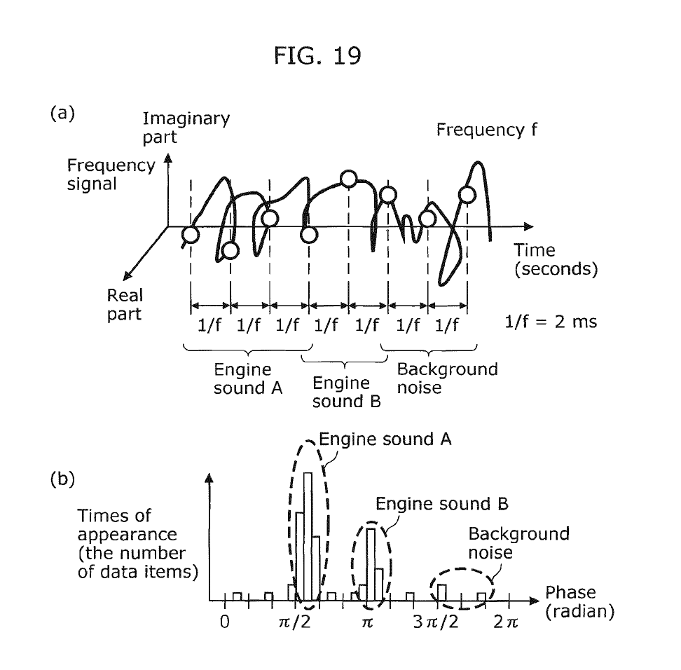

FIG. 19 shows an example of frequency signals selected by the frequency signal selection unit 200(j) and a histogram of the selected phases. Here, the analysis is made using Δψ(i) (i=1 to L) finer than in the case of the histogram in FIG. 18. Here, only some of the selected frequency signals of mixed sounds 2401(n) are displayed.

FIG. 19(a) shows the selected frequency signals. The way of presentation in FIG. 19(a) is the same as in FIG. 11, and thus no description thereof is repeated. In this example, the selected frequency signals include frequency signals of an engine sound A (toned sound), an engine sound B (toned sound), and a background noise (toneless sound).

FIG. 19 shows an exemplary method of generating a histogram of the phases of frequency signals. In this example, a group of frequency signals of the engine sound A has a similar phase (near π/2 (radian)) in this example, and a group of frequency signals of the engine sound B has a similar phase (near π (radian)), and thus the histogram has two peaks near π/2 (radian) and π (radian). On the other hand, the frequency signals of the background noise do not have any specific phase, and thus no peak is present in the histogram.

For this, the phase distance determination unit 201(j) determines, to be frequency signals 2408 of the to-be-extracted sound, the frequency signals each having a phase distance equal to or less than the second threshold value (π/4 (radian)) and having the number of times of appearance equal to or greater than the first threshold value (corresponding to 30 percent of the number of all the frequency signals having a 1/f time interval included in the predetermined time width). In this example, the frequency signals near π/2 (radian) and the frequency signals near π (radian) are determined to be the frequency signals 2408 of the to-be-extracted sound. At this time, the phase distances between frequency signals near π/2 (radian) and frequency signals near π (radian) are equal to or greater than π/4 (radian) (a fourth threshold value). For this, the groups of frequency signals represented by the respective peaks can be determined to be different kinds of to-be-extracted sounds. More specifically, the respective engine sound A and engine sound B can be separately determined to represent frequency signals of two different to-be-extracted sounds.

Lastly, the sound extraction unit 202(j) can remove noises by extracting each of the frequency signals of the different kinds of to-be-extracted sounds (Step S402(j)).

With this structure, the to-be-extracted sound determination unit classifies the frequency signals into groups of frequency signals satisfying the conditions of (i) being equal to or greater than the first threshold value in number, and (ii) having a degree of similarity equal to or less than the second threshold value between the constituent frequency signals. In addition, the to-be-extracted sound determination unit determines, to be of different kinds of to-be-extracted sounds, the frequency signal groups between which the phase distance is equal to or greater than the fourth threshold value. These processes make it possible to separately determine possible plural kinds of to-be-extracted sounds in the same time-frequency domain. For example, it is possible to separate engine sounds from plural vehicles and separately determine the frequency signals of the respective engine sounds. For this, applying this embodiment to a vehicle detection device allows a driver to recognize that plural vehicles are present in the same direction, and thus to drive safely. In addition, this application allows separate determination of voices of plural humans. For this, applying this embodiment to a sound extraction device allows separate outputs of the voices as sounds.

Embedding a noise removal device according to the present invention into, for example, a sound output device makes it possible to determine, on a per time-frequency domain basis, frequency signals of a sound in a mixed sound, and subsequently output a clear sound by performing inverse frequency transform. In addition, embedding a noise removal device according to the present invention into, for example, a sound source direction detection device makes it possible to determine an accurate sound source direction by extracting the frequency signals of a to-be-extracted sound from which noises have been removed. In addition, embedding a noise removal device according to the present invention into, for example, a voice recognition device makes it possible to accurately perform voice recognition by extracting, on a per time-frequency domain basis, frequency signals of a to-be-extracted sound in a mixed sound even when noises are present around the to-be extracted sound. In addition, embedding a noise removal device according to the present invention into, for example, a sound recognition device makes it possible to accurately perform sound recognition by extracting, on a per time-frequency domain basis, frequency signals of a to-be-extracted sound in a mixed sound even when noises are present around the to-be-extracted sound. In addition, embedding a noise removal device according to the present invention into, for example, a vehicle detection device makes it possible to notify the presence of an approaching vehicle each time of extracting, on a per time-frequency domain basis, a frequency signal of an engine sound in a mixed sound. In addition, embedding a noise removal device according to the present invention into, for example, an emergency vehicle detection device makes it possible to notify the presence of an approaching emergency vehicle each time of extracting, on a per time-frequency domain basis, a frequency signal of a siren sound in a mixed sound.

In addition, considering extraction of a frequency signal of a noise (a toneless sound) that has not been determined to be of a to-be-extracted sound (a toned sound) in the present invention, embedding a noise removal device according to the present invention into, for example, a wind noise level determination device makes it possible to extract, on a per time-frequency domain basis, frequency signals of the wind noise in a mixed sound, calculate the signal powers, and output information indicating the signal powers. In addition, embedding a noise removal device according to the present invention into, for example, a vehicle detection device makes it possible to extract, on a per time-frequency domain basis, frequency signals of a running sound due to friction of tires in a mixed sound, and detect the presence of an approaching vehicle based on the signal powers.

It is to be noted that, as a frequency analysis unit, a cosine transform filter, a Wavelet transform filter, or a band-pass filter may be used.

It is to be noted that, as a window function used by the frequency analysis unit, any window functions such as a Hamming window, a rectangular window, or a Blackman window may be used.

It is to be noted that different values may be used as a center frequency f of the frequency signal generated by the frequency analysis unit and the reference frequency f′ used for phase distance calculation. At this time, when a frequency signal in the frequency f′ is present in the frequency signal having a center frequency f, the frequency signal is determined to be a frequency signal of the to-be-extracted sound. In addition, the frequency signal is specifically f′.

In Embodiment 1, the to-be-extracted sound determination unit 101(j) (j=1 to M) selects frequency signals in time segments K (time widths of 96 ms) equal in length in past and future time from among the time points at a 1/f (f denotes a reference frequency) time interval, but time segments may be selected in time segments different in length for past and future time.

In Embodiment 1, analysis-target frequency signals used to calculate phase distances are set, and whether or not the frequency signal at each time point is a frequency signal of a to-be-extracted sound is determined, but it is possible to collectively determine whether or not all of frequency signals are frequency signals of a to-be-extracted sound by calculating the phase distances between frequency signals altogether and comparing each of the phase distances with a second threshold value. In this case, a temporal variation in an average phase in the time segment is analyzed. For this, it is possible to steadily determine frequency signals of a to-be-extracted sound even when the phase of a noise accidentally matches the phase of the to-be-extracted sound.

It is to be noted that the time axis adjustment unit may set plural directions as predetermined directions, and determine frequency signals in each of the directions.

### Embodiment 2

Next, a noise removal device according to Embodiment 2 is described. Unlike the noise removal device according to Embodiment 1, the noise removal device according to Embodiment 2 removes noises based on phase differences between microphones, calculates the phase distances, determines frequency signals of each of to-be-extracted sounds, and then removes the remaining noises. In addition, the noise removal device modifies the phase ψ(t) (radian) of a frequency signal at a current time point t of a mixed sound to ψ′(t) according to the expression ψ′(t)=mod 2π(ψ(t)−2πft) (here, f denotes a reference frequency), determines a frequency signal of the to-be-extracted sound, based on the modified phase ψ′(t) of the frequency signal, and removes noises.

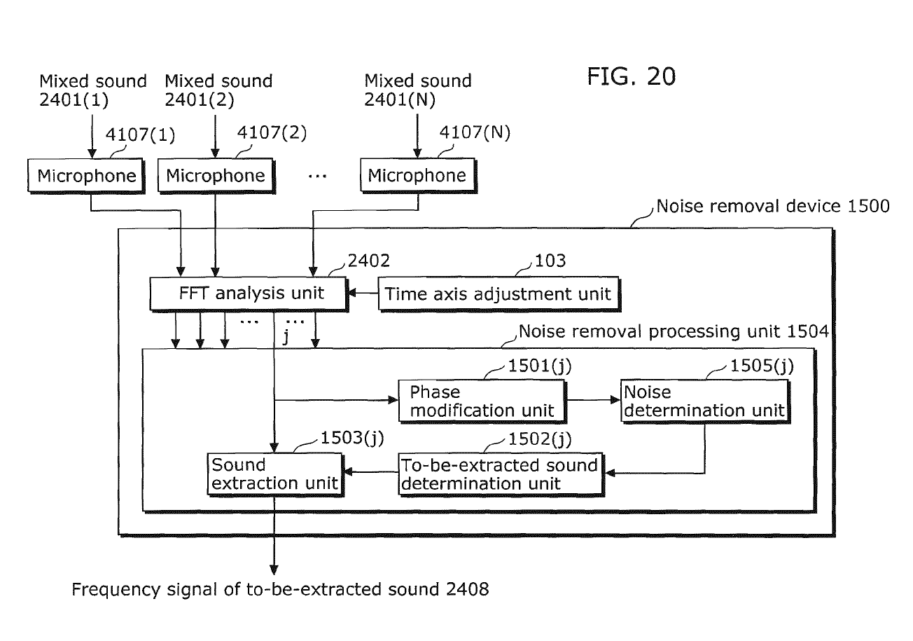

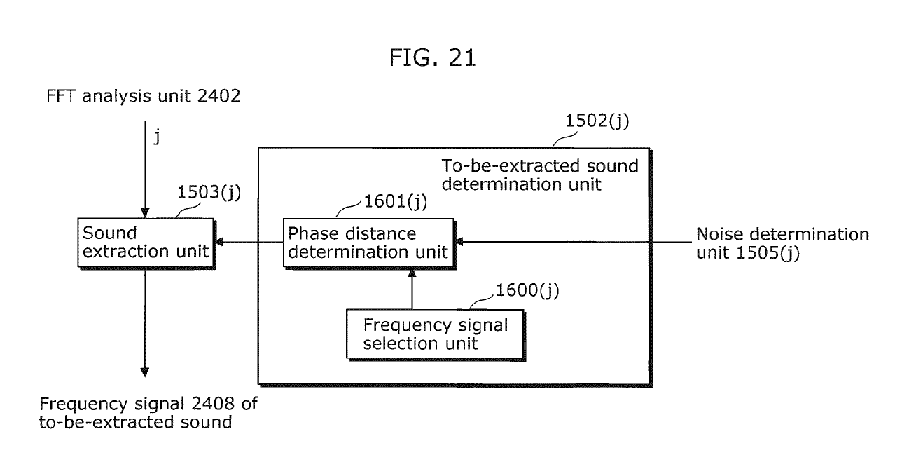

Each of FIG. 20 and FIG. 21 is a block diagram showing the structure of the noise removal device according to Embodiment 2 of the present invention.

In FIG. 20, the noise removal device 1500 includes: a time axis adjustment unit 103; an FFT analysis unit 2402 (frequency analysis unit); and a noise removal processing unit 1504 including a phase modification unit 1501(j) (j=1 to M); a noise determination unit 1505(j) (j=1 to M); a to-be-extracted sound determination unit 1502(j) (j=1 to M), and a sound extraction unit 1503(j) (j=1 to M).

The FFT analysis unit 2402 receives the mixed sounds 2401(n) (n=1 to N), performs fast Fourier transform thereon, and determines, on a per time point basis, frequency signals of the mixed sounds 2401(n) (n=1 to N) included in the predetermined time width on the time axes adjusted, by the time axis adjustment unit 103, such that the difference in the arrival time points at the respective microphones are zero with respect to the sound arriving in the predetermined direction. Hereinafter, it is assumed that the number of frequency w bands of each of the frequency signals determined by the FFT analysis unit 2402 is denoted as M, and that the numbers specifying the respective frequency bands are denoted as j (j=1 to M).

The phase modification unit 1501(j) (j=1 to M) is a processing unit that modifies the phases of the frequency signals in the frequency band j determined by the FFT analysis unit 2402 to the phase ψ′(t) according to the expression ψ′(t)=mod 2π(ψ(t)−2πft) (here, f denotes a reference frequency) when the phase ψ(t) (radian) of the frequency signal at a time pint t.

Among the frequency signals of the mixed sounds 2401(n) (n=1 to N) calculated by the FFT analysis unit 2402, the noise determination unit 1505(j) (j=1 to M) determines frequency signals of a mixed sound having phase distances equal to or greater than a third threshold value from the phases of all the other frequency signals of the mixed sounds, at each of time points for which the time axis has been adjusted toward a predetermined direction. In this example, the phase differences are calculated using the phases modified by the phase modification unit 1501(j) (j=1 to M).

It is to be noted that the noise determination unit 1505(j) (j=1 to M) may calculate the phase differences using the unmodified phases of the frequency signals determined by the FFT analysis unit 2402.

The to-be-extracted sound determination unit 1502(j) (j=1 to M) calculates the phase distances between (i) the analysis-target frequency signals having modified phases and (ii) the frequency signals (of the mixed sounds 2401(n) (n=1 to N) having modified phases in the predetermined time width, using the frequency signals obtained by subtracting the frequency signals determined by the noise determination unit 1505(j) (j=1 to M) from the frequency signals, of the mixed sounds 2401(n) (n=1 to N), determined by the FFT analysis unit 2402 in the predetermined time width on the time axis adjusted by the time axis adjustment unit 103. At this time, the number of frequency signals used to calculate the phase distances is equal to or greater than a first threshold value. The phase distances are calculated using ψ′(t). The analysis-target frequency signals having phase distances equal to or less than a second threshold value are determined to be frequency signals 2408 of the to-be-extracted sound.

At this time, it is also possible to determine the mixed sound 2401(n) (n=1 to N) from which a frequency signal of one of the to-be-extracted sounds is determined.

Lastly, the sound extraction unit 1503(j) (j=1 to M) removes noises from the mixed sound by extracting the frequency signals 2408, of the to-be-extracted sound, determined by the to-be-extracted sound determination unit 1502 (j) (j=1 to M).

Performing this processing at sequentially-shifted time points having a predetermined time width makes it possible to extract the frequency signals 2408 of the to-be-extracted sound on a per time-frequency domain basis.

FIG. 21 is a block diagram showing the structure of the to-be-extracted sound determination unit 1502(j) (j=1 to M).

The to-be-extracted sound determination unit 1502(j) (j=1 to M) includes a frequency signal selection unit 1600(j) (j=1 to M) and a phase distance determination unit 1601(j) (j=1 to M).

The frequency signal selection unit 1600(j) (j=1 to M) is a processing unit that selects, in a predetermined time width, a frequency signal to by used by the phase distance determination unit 1601(j) (j=1 to M) in calculating a phase distance, from among the frequency signals obtained by subtracting the frequency signals determined by the noise determination unit 1505(j) (j=1 to M) from the frequency signals having a phase modified by the phase modification unit 1501(j) (j=1 to M). The phase distance determination unit 1601(j) (j=1 to M) is a processing unit that calculates the phase distances using the modified phases ψ′(t) of the frequency signals selected by the frequency signal selection unit 1600(j) (j=1 to M), and determines the frequency signal that yields a phase distance not greater than the second threshold value to be a frequency signal 2408 of the to-be-extracted sound.

Next, a description is given of operations performed by the noise removal device 1500 configured as described above.

The following describes processing performed on a j-th frequency band. Here, a description is given of an exemplary case where the center frequency of the frequency band matches the reference frequency (frequency f according to the expression ψ′(t)=mod 2π(ψ(t)−2πft) to be used for calculating the phase distance in determination on whether or not a to-be-extracted sound is present in the frequency f). Another method may be used to determine the to-be-extracted sound assuming that plural frequencies including the frequency band is the reference frequencies. In this case, it is possible to determine whether or not a to-be-extracted sound is present in the frequency around the center frequency. The processing is the same as in Embodiment 1.

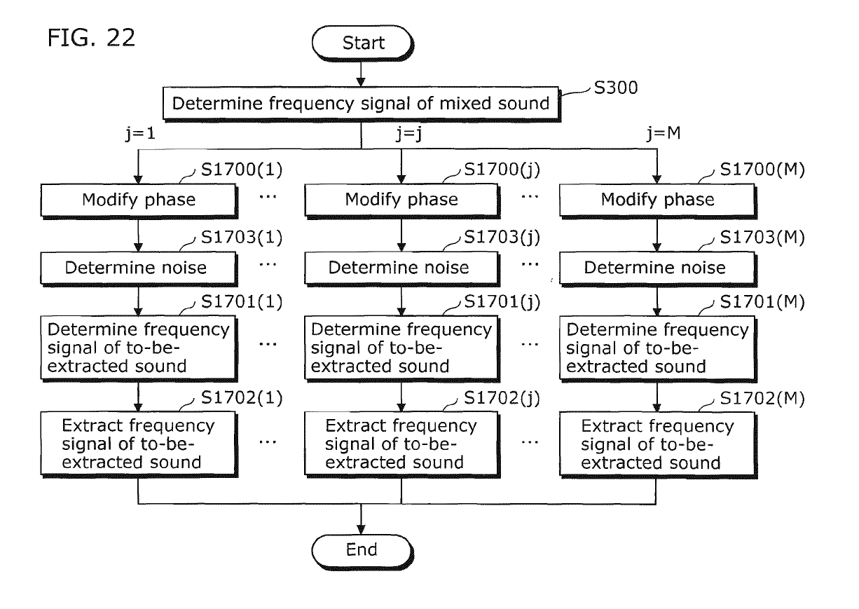

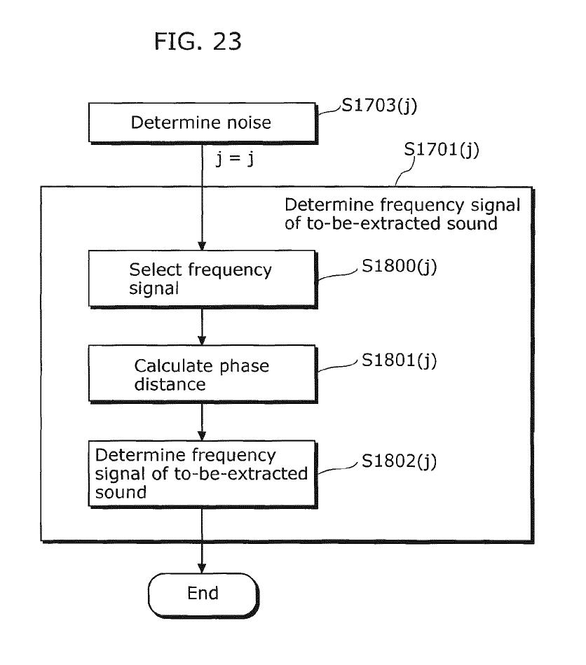

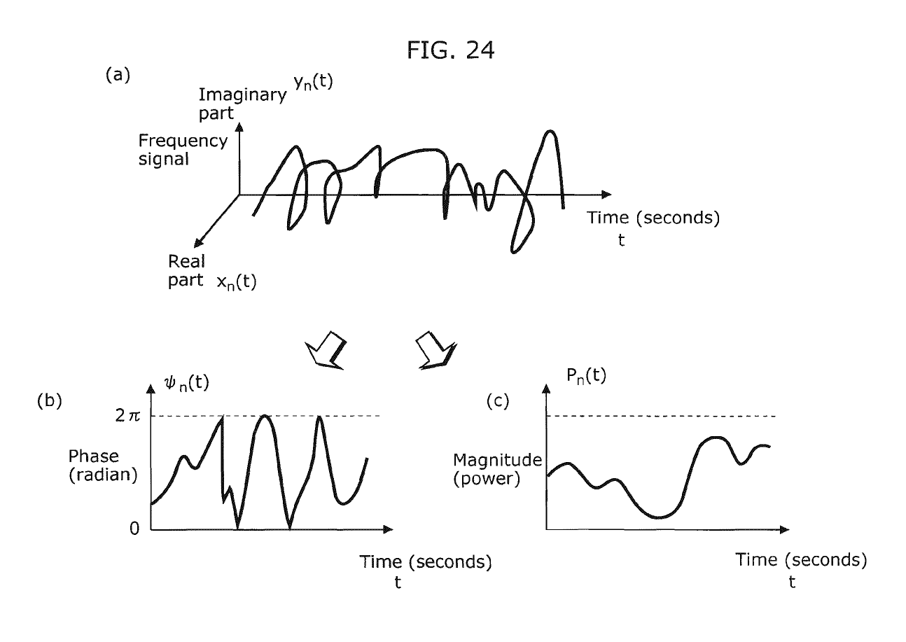

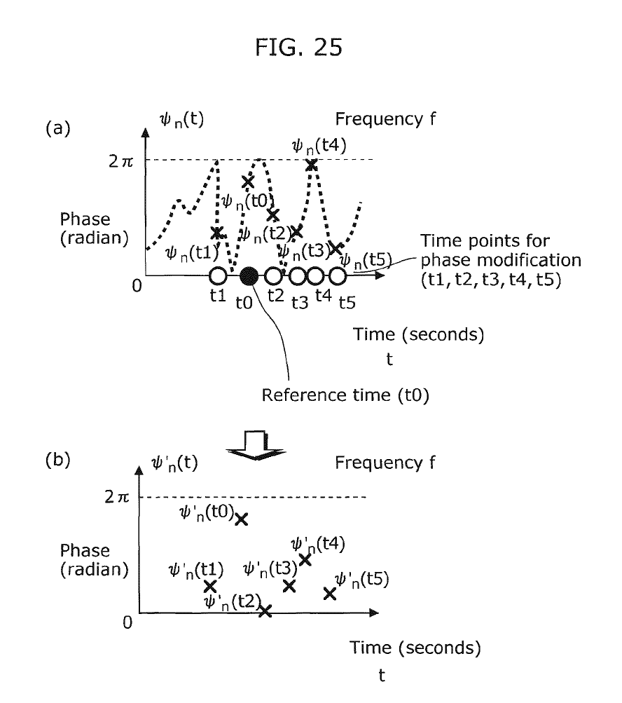

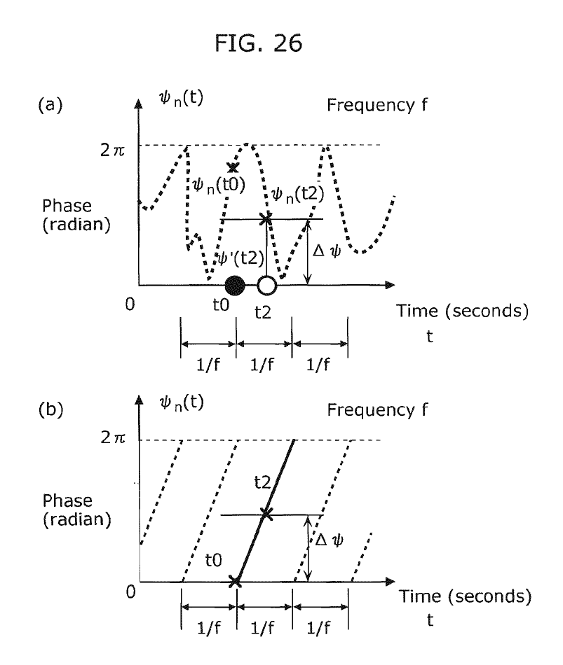

FIGS. 22 and 23 is a flowchart showing a procedure of operations performed by a noise removal device 1500.

The FFT analysis unit 2402 receives the mixed sounds 2401(n) (n=1 to N), performs fast Fourier transform thereon, and determines frequency signals of the mixed sounds 2401(n) (n=1 to N) included in the predetermined time width on the time axes adjusted, by the time axis adjustment unit 103, such that the difference in the arrival time points at the respective microphones are zero with respect to the sound arriving in the predetermined direction (Step S300). Here, the frequency signals are determined in the same manner as in Embodiment 1.

Next, the phase modification unit 1501(j) modifies the phases of the frequency signals, in the frequency band j of the mixes sounds 2401(n) (n=1 to N), determined by the FFT analysis unit 2402 by converting the phases according to the expression ψ′(t)=mod 2π(ψ(t)−2πft) (here, f denotes a reference frequency) when the phase ψ(t) (radian) of the frequency signal at a current time point t is the phase ψ′(t) (Step S1700(j)).

With reference to FIGS. 24 to 26, an exemplary phase modification method is described. FIG. 24(a) schematically shows frequency signals determined by the FFT analysis unit 2402. FIG. 24(b) schematically shows the phases of the frequency signals determined based on FIG. 24(a). FIG. 24(c) schematically shows the magnitudes (power) of the frequency signals determined based on FIG. 24(a). The horizontal axes in FIGS. 24(a) to 24(c) are time axes. The way of presentation in FIG. 24(a) is the same as in FIG. 11, and thus no description thereof is repeated. FIG. 24(a) shows only some of the frequency signals of one of the mixed sounds 2401(n) (n=1 to M). The vertical axis in FIG. 24(b) represents the phases of the frequency signals, and the phases are shown as values within a range from 0 to 2π (radian). The vertical axis in FIG. 24(c) represents the magnitudes (power) of the frequency signals. The phases ψn(t) (n=1 to N) and the magnitudes (power) Pn(t) (n=1 to N) of the frequency signals of the mixed sounds 2401(n) (n=1 to N) are calculated when the real part and imaginary part are expressed by the following expressions.

xₙ(t) (n=1, . . . , N) [Expression 15]

yₙ(t) (n=1, . . . , N) [Expression 16]

At this time, the following two expressions are satisfied.

φₙ(t)=mod 2π(arctan(yₙ(t)/xₙ(t))) (n=1, . . . , N) [Expression 17]

Pₙ(t)=\sqrt{xₙ(t)²+yₙ(t)²} (n=1, . . . , N) [Expression 18]

The symbol t denotes the time point of a frequency signal.

Phase modification is performed by converting the phase ψn(t) (n=1 to N) of each frequency signal shown in FIG. 24(b) into the phase corresponding to the value obtained according to the expression ψ′n(t)=mod 2π(ψ(t)−2πft) (here, f denotes a reference frequency).

First, a reference time point is determined. FIG. 25(a) has the same content as in FIG. 24(b), and in this example of FIG. 25(a), the time point t0 marked with a filled circle is determined to be the reference time point.

Next, determinations are made on plural time points of frequency signals whose phases to be modified. In this example of FIG. 25(a), the five time points (t1 to t5) marked with open circles are determined to be the plural time points of frequency signals whose phase are to be modified.

Here, the phase of the frequency signal at the reference time point t0 is represented as indicated below.

φₙ(t₀)=mod 2π(arctan(yₙ(t₀)/xₙ(t₀))) (n=1, . . . , N) [Expression 19]

The phases of the frequency signals at the five time points and having phases to be modified are represented as indicated below.

φₙ(tᵢ)=mod 2π(arctan(yₙ(tᵢ)/xₙ(tᵢ))) (n=1, . . . , N) (i=1,2,3,4,5) [Expression 20]

The original phases before such modifications are shown with x marks in FIG. 25(a).

In addition, the magnitudes of the frequency signals at the time points can be represented as indicated below.

Pₙ(tᵢ)=\sqrt{xₙ(tᵢ)²+yₙ(tᵢ)²} (n=1, . . . , N) (i=1,2,3,4,5) [Expression 21]

Next, FIG. 26 shows a method of modifying the phase of the frequency signal at the time point t2. FIG. 26(a) has the same content as in FIG. 25(a). In addition, FIG. 26(b) shows phases that shift regularly at a 1/f (f denotes a reference frequency) time interval to 0 to 2π (radian) at an equal angle speed.

Here, the modified phase is represented as indicated below.

φ′ₙ(tᵢ) (n=1, . . . N) (i=0,1,2,3,4,5) [Expression 22]

Comparison based on FIG. 26(b) shows that the phase at the time point t2 is larger than the phase at the reference time point t0 by the value indicated below.

Δφ=2πf(t₂−t₀) [Expression 23]

For this reason, in order to modify the phase difference, in FIG. 26(a), due to time difference from the reference time point t0 corresponding to the phase ψn (t0), ψ′n (t2) is calculated by subtracting Δψ from the phase ψn (t2) at the time point t2. The resulting phase ψ′n (t2) is the modified phase at the time point t2. At this time, since the phase at the time point t0 is the phase at the reference time point, the modified phase has the same value.

More specifically, the modified phase is calculated according to the two expressions indicated below.

φ′ₙ(t₀)=φₙ(t₀) (n=1, . . . , N) [Expression 24]

φ′ₙ(tᵢ)=mod 2π(φₙ(tᵢ)−2πf(tᵢ−t₀)) (n=1, . . . , N) (i=1,2,3,4,5) [Expression 25]

The modified phases of the frequency signals are marked with x in FIG. 25(b). The way of presentation in FIG. 25(b) is the same as in FIG. 25(a), and thus no description thereof is repeated.

Among the frequency signals of the mixed sounds 2401(n) (n=1 to N) determined by the FFT analysis unit 2402, the noise determination unit 1505(j) determines frequency signals of a mixed sound having phase distances equal to or greater than the third threshold value from the phases of all the other frequency signals of the mixed sounds, at each of time points for which the time axis has been adjusted toward the predetermined direction (Step S1703(j)). In this example, the phase differences are calculated using the phases modified by the phase modification unit 1501(j).

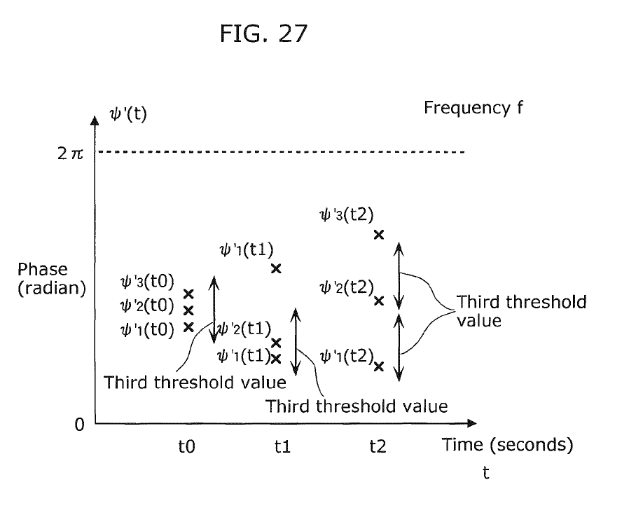

FIG. 27 shows an example of phases modified by the phase modification unit 1501(j). The way of presentation is the same as in FIG. 25(b), and thus no description thereof is repeated. The time axes here have been adjusted in the predetermined direction. This example shows the modified phases at the time points t0, t1, and t2 of the mixed sounds 2401(n) (n=1 to N). Here, a description is given of assuming that N=3.

At the time point t0 in FIG. 27, the phase ψ′1 (t0) of the mixed sound 2401(1) has a phase difference below the third threshold value from either the phase ψ′2 (t0) of the mixed sound 2401(2) or the phase ψ′3 (t0) of the mixed sound 2401(3). Thus, the phase ψ′1 (t0) of the mixed sound 2401(1) remains as a candidate for a frequency signal of a to-be-extracted sound. Similarly, the phase ψ′2 (t0) (a frequency signal) of the mixed sound 2401(2) and the phase ψ′3 (t0) (a frequency signal) of the mixed sound 2401(3) remain as candidates for frequency signals of the to-be-extracted sounds.

At the time point t1 in FIG. 27, the phase ψ′3 (t1) (a frequency signal) of the mixed sound 2401(3) has a phase difference equal to or greater than the third threshold value from both the phase ψ′2 (t1) of the mixed sound 2401(1) and the phase ψ′2 (t1) of the mixed sound 2401(2). Thus, the phase ψ′3 (t1) of the mixed sound 2401(3) is determined to be a noise. In addition, the phase difference between the phase ψ′1 (t1) (a frequency signal) of the mixed sound 2401(1) and the phase ψ′2 (t1) (a frequency signal) of the mixed sound 2401(2) is below the third threshold value. Thus, the phase ψ′1 (t1) of the mixed sound 2401(1) and the phase ψ′2 (t1) of the mixed sound 2401(1) remain as candidates for frequency signals of to-be-extracted sounds. At the time point t2 in FIG. 27, the phase difference between the phase ψ′1 (t2) (a frequency signal) of the mixed sound 2401(1) and the phase ψ′2 (t2) (a frequency signal) of the mixed sound 2401(2) is equal to or greater than the third threshold value. Thus, the phase ψ′2 (t2) of the mixed sound 2401(2) and the phase ψ′3 (t2) of the mixed sound 2401(3) are determined to be noises.

In this way, it is possible to remove frequency signals of noises before phase distance calculation.

It is to be noted that the noise determination unit 1505(j) (j=1 to M) may calculate the phase differences using the unmodified phases of the frequency signals determined by the FFT analysis unit 2402. In this case, it is good to perform a method similar to the method shown in FIG. 27 using the phase ψ(t) as a replacement for the phase ψ′(t) in FIG. 27.

Next, the to-be-extracted sound determination unit 1502(j) calculates the phase distances between (i) the analysis-target frequency signals having modified phases and (ii) the frequency signals (of the mixed sounds 2401(n) (n=1 to N) having modified phases in the predetermined time width, using the frequency signals obtained by subtracting the frequency signals determined by the noise determination unit 1505(j) from the frequency signals, of the mixed sounds 2401(n) (n=1 to N), determined by the FFT analysis unit 2402 in the predetermined time width on the time axis adjusted by the time axis adjustment unit 103. At this time, the number of frequency signals used to calculate the phase distances is equal to or greater than a first threshold value. Subsequently, the to-be-extracted sound determination unit 1502(j) determines, to be frequency signals 2408 of the to-be-extracted sound, the analysis-target frequency signals having a phase distance equal to or less than the second threshold value (Step S1701(j)).

First, the frequency signal selection unit 1600(j) selects frequency signals to be used by the phase distance determination unit 1601(j) in performing phase distance calculation, from among the frequency signals obtained by subtracting the frequency signals determined by the noise determination unit 1505(j) from the frequency signals having a modified phase calculated by the phase modification unit 1501(j) in the predetermined time width (Step S1800(j)). Here, assuming that the frequency signals obtained by subtracting the frequency signals determined by the noise determination unit 1505(j) in the predetermined time width are present at the time points t0 to t5, the analysis-target frequency signals are determined to be frequency signals at the time point t0 of the mixed sound 2401(n′). At this time, the number of frequency signals of the mixed sound 2401(n) (n=1 to N) used for phase distance calculation is equal to or greater than the first threshold value (here, the number or frequency signals at the time points t0 to t5 corresponds to a value obtained by multiplying 6 items by N). This threshold is placed because it is difficult to determine regularity of a temporal variation in phase when the number of frequency signals selected to calculate the phase distance is not sufficient. The time length corresponding to the predetermined time width used here is preferably set to be within 2 to 4 times the time window width of the window function in the fast Fourier transform performed by the FFT analysis unit 2402.

Next, the phase distance determination unit 1601(j) performs phase distance calculation using the frequency signals, having modified phases, selected by the frequency signal selection unit 1600(j) (Step S1801(j)).

In this example, the phase distance S denotes a phase difference error, and calculated according to the following Expression 26.

S=1/5NΣₙ₌₁^{n=N}Σᵢ₌₁ⁱ⁼⁵{square root over ((φ′_{n′}(t₀)−φ′ₙ(tᵢ))²)} [Expression 26]

In addition, when the analysis-target frequency signals are the frequency signals at time point t2 of the mixed sound 2401(n′), the phase difference is as indicated below.

S=1/5N(Σₙ₌₁^{n=N}Σᵢ₌₀ⁱ⁼¹{square root over ((φ′_{n′}(t₂)−φ′ₙ(tᵢ))²)}+Σₙ₌₁^{n=N}Σᵢ₌₃ⁱ⁼⁵{square root over ((φ′_{n′}(t₂)−φ′ₙ(tᵢ))²))} [Expression 27]

It is also good to calculate a phase distance considering that the phase values are in a torus (that is, 0 (radian) and 2π (radian) are the same).

For example, in the case of calculating a phase distance using the phase difference error shown in Expression 26, it is also good to calculate a phase distance using the following right term.

(φ′_{n′}(t₀)−φ′ₙ(tᵢ))²≡min{(φ′_{n′}(t₀)−φ′ₙ(tᵢ))², (φ′_{n′}(t₀)−(φ′ₙ(tᵢ)+2π))², (φ′_{n′}(t₀)−(φ′ₙ(tᵢ)−2π))²} [Expression 28]

In this example, the frequency signal selection unit 1600(j) selects frequency signals to be used by the phase distance determination unit 1601(j) in performing phase distance calculation, from among the frequency signals having phases modified by the phase modification unit 1501(j). Other possible methods include a method in which the frequency signal selection unit 1600(j) selects, in advance, frequency signals whose phases are modified by the phase modification unit 1501(j), and the phase distance determination unit 1601(j) calculates the phase distances directly using the frequency signals whose phases have been modified by the phase modification unit 1501(j). In this case, it is possible to reduce the processing amount because it is only necessary to modify the phases of the frequency signals used for phase distance calculation.

Next, the phase distance determination unit 1601(j) determines, to be a frequency signal 2408 of the to-be-extracted sound, each of the analysis-target frequency signals having a phase distance equal to or less than the second threshold value (Step S1802(j)).

Lastly, the sound extraction unit 1503(j) removes noises by extracting the frequency signals that the to-be-extracted sound determination unit 1502(j) has determined to be frequency signals 2408 of the to-be-extracted sound. Here, a consideration is given of the phases of frequency signals to be removed as noises. In this example, the phase distance is regarded as a phase difference error. Here, the second threshold value is set to π (radian).

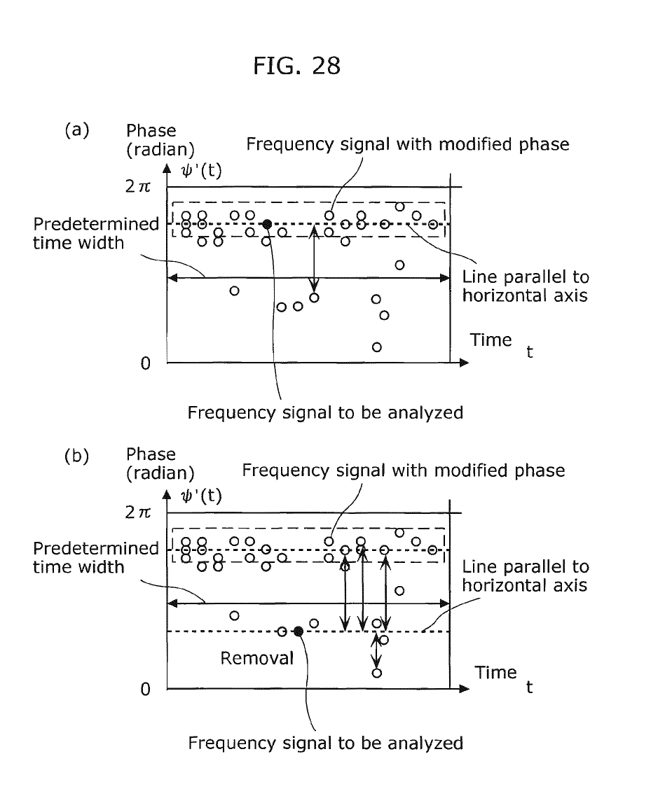

FIG. 28 is a diagram schematically showing the modified phases ψ′(t) of frequency signals, of a mixed sound, in the predetermined time width used for phase distance calculation. The horizontal axis represents time t, and the vertical axis represents modified phases ψ′(t). Each of the filled circles shows a current phase of the analysis-target frequency signal. As shown in FIG. 28(a), phase distance calculation performed is calculating a phase distance from a straight line which has a slope parallel to the time axis and passes through the modified phase of the analysis-target frequency signal. In FIG. 28(a), modified phases of the frequency signals whose phase distances are calculated are present near the straight line. For this, the phase distances from the frequency signals equal to or greater than the first threshold value in number are equal to or less than the second threshold value (π (radian)), and the analysis-target frequency signals are determined to be frequency signals of a to-be-extracted sound. In addition, as shown in FIG. 28(b), when almost no frequency signals whose phase distances are calculated are present near the straight line which has a slope parallel to the time axis and passes through the modified phase of the analysis-target frequency signal, the phase distances from the frequency signals in number equal to or greater than the first threshold value are greater than the second threshold value (π (radian)). For this, there is no possibility that the analysis-target frequency signals are determined to be frequency signals of a to-be-extracted sound, and such frequency signals are removed as noises.

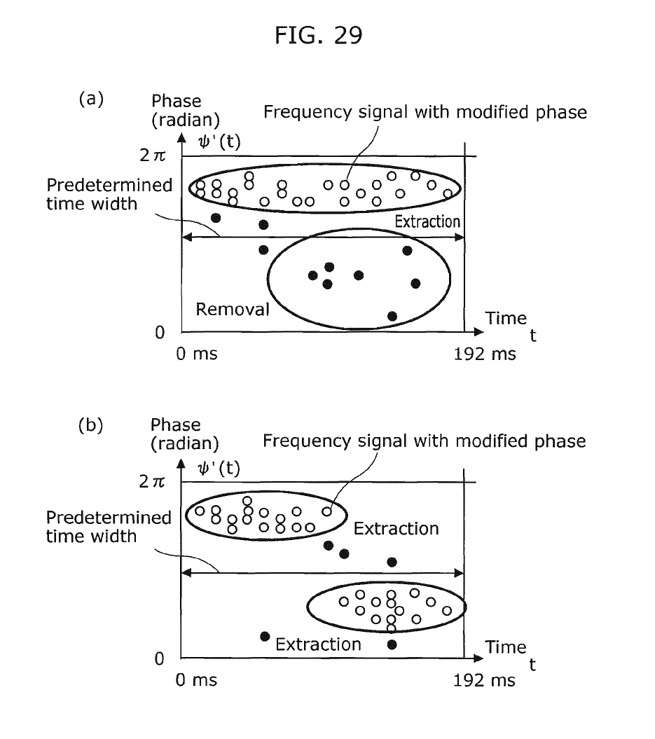

FIG. 29 schematically shows another example of phases of a mixed sound. The horizontal axis is the time axis, and the vertical axis is the phase axis. The modified phases of the frequency signals of the mixed sound are marked with circles. Each of solid lines encloses the frequency signals that belong to a same cluster and has a phase distance between the frequency signals that is equal to or less than the second threshold value (π (radian)). These clusters can also be determined using multivariate analysis. The frequency signals in a cluster in which the number of the constituent frequency signals is equal to or greater than the first threshold value are not removed but extracted, and the frequency signals in a cluster in which the number of the constituent frequency signals is less than the first threshold value are removed as being noises. As shown in FIG. 29(a), in the case where a noise portion is included in the predetermined time width, it is possible to remove only the noise portion. In addition, as shown in FIG. 29(b), in the case where two kinds of to-be-extracted sounds are present, it is possible to extract the two kinds of to-be-extracted sounds by extracting two frequency signal clusters each of which includes such frequency signals that (i) have a phase distance equal to or greater than the second threshold value (π (radian)) between the frequency signals and (ii) account for 40 percent or more in number (here, 7 or more) of the frequency signals present in the predetermined time width. At this time, the phase distance between these clusters is equal to or greater than π (radian) (the fourth threshold value), and thus the frequency signals in the respective clusters can be determined to be different kinds of to-be-extracted sounds.

The sound determination device is configured to remove noises represented by the frequency signals having a phase difference, of the mixed sounds, equal to or greater than the third threshold value between microphones, and determine frequency signals of a to-be-extracted sound without the noises. Therefore, the sound determination device is capable of performing an accurate determination using the first threshold value, and performing an accurate determination of the to-be-extracted sound. For example, wind noises received through the respective microphones have different phases, and thus they can be removed using the third threshold value.

In addition, in the case of the sounds that are present in the direction other than the predetermined direction and received through the respective microphones, the frequency signals, between the microphones, which have phases adjusted in the time axis with respect to the predetermined direction have a great phase difference. Therefore, it is possible to remove noises using the third threshold value.

In addition, removing frequency signals, of the mixed sound, which yield a phase difference equal to or greater than the third threshold value from all the other frequency signals of the mixed sounds makes it possible to determine frequency signals of the to-be-extracted sounds without removing the frequency signals which may represent the to-be-extracted sounds. For example, in the case where noises such as wind noises are received through one of the microphones independently, removing all the frequency signals other than the frequency signals having similar phase differences between all the microphones inevitably removes all the frequency signals even when a to-be-extracted sound is received through the other microphone(s).

In addition, modifying the phases of the frequency signals at a time interval finer than the 1/f (f denotes a reference frequency) time interval according to the simple expression ψ′(t)=mod 2π(ψ(t)−2πft) using ψ′(t). For this, it is possible to determine the frequency signals of a to-be-extracted sound on a per short time domain basis even in a low frequency band with a long 1/f time interval, using the simple expression ψ′(t)=mod 2π(ψ(t)−2ψft).

Embedding a noise removal device according to the present invention into, for example, a sound output device makes it possible to determine, on a per time-frequency domain basis, frequency signals of a sound in a mixed sound, and subsequently output a clear sound by performing inverse frequency transform. In addition, embedding a noise removal device according to the present invention into, for example, a sound source direction detection device makes it possible to determine an accurate sound source direction by extracting the frequency signals of a to-be-extracted sound from which noises have been removed. In addition, embedding a noise removal device according to the present invention into, for example, a voice recognition device makes it possible to accurately perform voice recognition by extracting, on a per time-frequency domain basis, frequency signals of a to-be-extracted sound in a mixed sound even when noises are present around the to-be extracted sound. In addition, embedding a noise removal device according to the present invention into, for example, a sound recognition device makes it possible to accurately perform sound recognition by extracting, on a per time-frequency domain basis, frequency signals of a to-be-extracted sound in a mixed sound even when noises are present around the to-be-extracted sound. In addition, embedding a noise removal device according to the present invention into, for example, a vehicle detection device makes it possible to notify the presence of an approaching vehicle each time of extracting, on a per time-frequency domain basis, a frequency signal of an engine sound in a mixed sound. In addition, embedding a noise removal device according to the present invention into, for example, an emergency vehicle detection device makes it possible to notify the presence of an approaching emergency vehicle each time of extracting, on a per time-frequency domain basis, a frequency signal of a siren sound in a mixed sound.

In addition, considering extraction of a frequency signal of a noise (a toneless sound) that has not been determined to be of a to-be-extracted sound (a toned sound) in the present invention, embedding a noise removal device according to the present invention into, for example, a wind noise level determination device makes it possible to extract, on a per time-frequency domain basis, frequency signals of the wind noise in a mixed sound, calculate the signal powers, and output information indicating the signal powers. In addition, embedding a noise removal device according to the present invention into, for example, a vehicle detection device makes it possible to extract, on a per time-frequency domain basis, frequency signals of a running sound due to friction of tires in a mixed sound, and detect the presence of an approaching vehicle based on the signal powers.

It is to be noted that, as a frequency analysis unit, a discrete Fourier transform filter, a cosine transform filter, a Wavelet transform filter, or a band-pass filter may be used.

It is to be noted that, as a window function used by the frequency analysis unit, any window functions such as a Hamming window, a rectangular window, or a Blackman window may be used.

The noise removal device 1500 removes noises from all (M in number) the frequency bands determined by the FFT analysis unit 2402, but it is also good to select some of the frequency bands from which noises are desired to be removed, and remove the noises from the selected frequency bands.

It is also possible to collectively determine whether or not plural frequency signals as a whole are of a to-be-extracted sound by calculating the phase distances between the plural frequency signals without determining analysis-target frequency signals and comparing the phase distances with the second threshold value. In this case, a temporal variation in an average phase in the time segment is analyzed. For this, it is possible to steadily determine frequency signals of a to-be-extracted sound even when the phase of a noise accidentally matches the phase of the to-be-extracted sound.

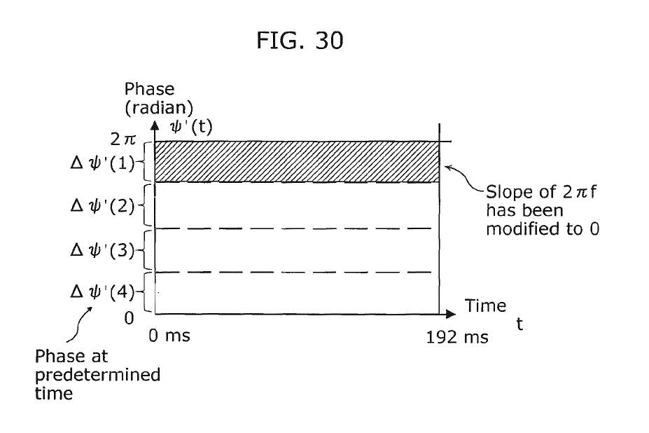

As with variation of Embodiment 1, it is also good to generate a histogram of phases of frequency signals, using the modified phases, and determine frequency signals of a to-be-extracted sound, with reference to the histogram. In this case, the histogram is as shown in FIG. 30. The way of presentation is the same as in FIG. 18, and thus no description thereof is repeated. The use of modified phases makes Δψ′ regions in the histogram parallel to the time axis, thereby facilitating calculation of the number of times of appearance.

It is also good to determine frequency signals of a to-be-extracted sound by determining the real part and the imaginary part of each frequency signal normalized by power, using the phase distances (Expressions 8, 9, and 10) in Embodiment 1 according to two expressions using the modified phase ψ′(t) indicated below.

x′ₙₜ=x′ₙ(t)=cos(φ′ₙ(t) (n=1, . . . , N) [Expression 29]

y′ₙₜ=y′ₙ(t)=sin(φ′ₙ(t)) (n=1, . . . , N) [Expression 30]

It is to be noted that the time axis adjustment unit may set plural directions as predetermined directions, and determine frequency signals in each of the directions.

### Embodiment 3

Next, a description is given of a vehicle detection device according to Embodiment 3. The vehicle detection device according to Embodiment 3 is intended to notify a driver of the fact that an approaching vehicle is present nearby by outputting a to-be-extracted sound detection flag when it is determined that a frequency signal of an engine sound (to-be-extracted sound) is present nearby. The difference from Embodiments 1 and 2 lies in that the time axis adjustment unit sets plural directions as predetermined directions, and determines to-be-extracted sounds in each of the directions. Here, a description is given of a method of determining a reference frequency suitable for a mixed sound on a per time-domain basis first at the time of calculating phase distances, and then determining the phase distances of to-be-extracted sounds with respect to the determined reference frequency, and determining frequency signals of an engine sound.

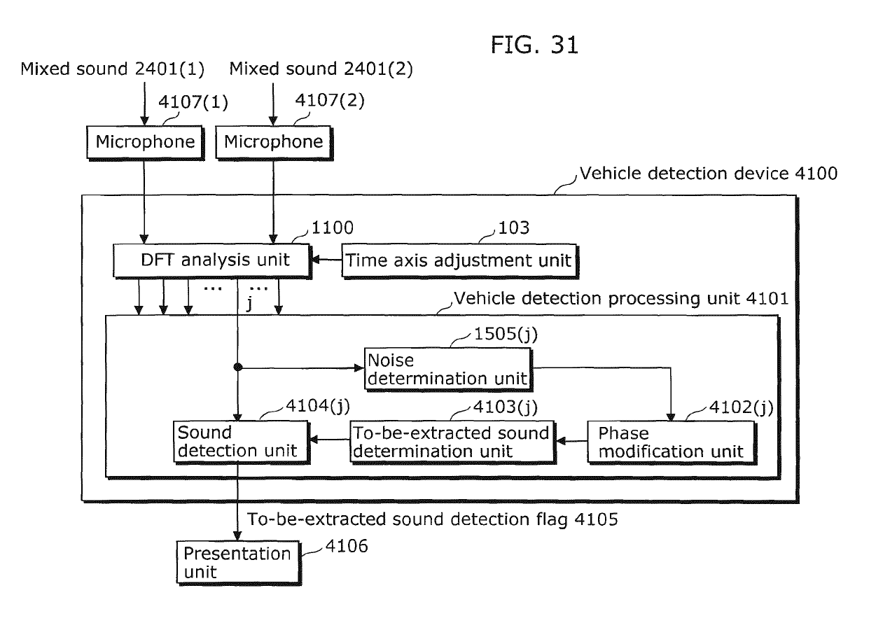

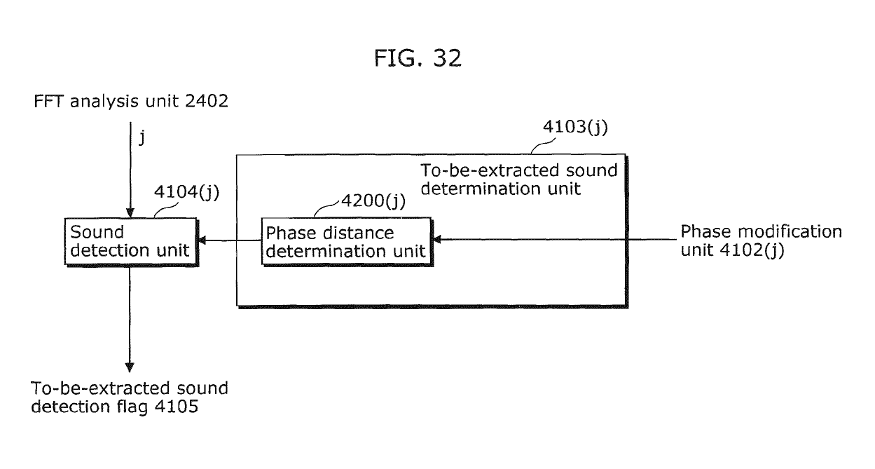

Each of FIG. 31 and FIG. 32 is a block diagram showing the structure of the vehicle detection device according to Embodiment 3 of the present invention.

In FIG. 31, the vehicle detection device 4100 includes: a microphone 4107(1); a microphone 4107(2); a time axis adjustment unit 103; a DFT analysis unit 1100 (frequency analysis unit); a vehicle detection processing unit 4101 including a noise determination unit 1505(j) (j=1 to M); a phase modification unit 4102(j) (j=1 to M), a to-be-extracted sound determination unit 4103(j) (j=1 to M), and a sound detection unit 4104(j) (j=1 to M); and a presentation unit 4106.

In addition, in FIG. 32, the to-be-extracted sound determination unit 4103(j) (j=1 to M) includes a phase distance determination unit 4200(j) (j=1 to M).

The microphone 4107(1) receives a mixed sound 2401(1), and the microphone 4107(2) receives a mixed sound 2401(2). In this example, the microphones 4107(1) and 4107(2) are set on front left and front right bumpers, respectively, of an own vehicle. The respective mixed sounds include a motorbike engine sound and a wind noise.

The DFT analysis unit 1100 receives mixed sounds 2401(n) (n=1, 2), and performs discrete Fourier transform thereon so as to determine frequency signals, of the mixed sounds 2401(n) (n=1, 2), which are at time points included in a predetermined time width on a time axis adjusted, by the time axis adjustment unit 103, such that the difference in the arrival time points of the mixed sounds arriving from predetermined directions is zero between the microphones. Here, plural directions are set as the predetermined directions. Hereinafter, it is assumed that the number of frequency bands of each of the frequency signals determined by the DFT analysis unit 1100 is denoted as M, and that the numbers specifying the respective as frequency bands are denoted as j (j=1 to M). In this example, the 10- to 150-Hz frequency band in which the motorbike engine sound is present is segmented at each 5-Hz interval, based on which M (M=30) frequency signals are determined.

Among the frequency signals of the mixed sounds 2401(n) (n=1, 2) calculated by the DFT analysis unit 1100, the noise determination unit 1505(j) (j=1 to M) determines frequency signals of a mixed sound having phase distances equal to or greater than a third threshold value from the phases of all the other frequency signals of the mixed sounds, at each of time points for which the time axis has been adjusted toward a predetermined direction. In this example, the phase differences are calculated using the phases calculated by the DFT analysis unit 1100. This processing is performed with adjustment of the time axis for each of the directions that the time axis adjustment unit 103 has set as the predetermined directions.

It is to be noted that the noise determination unit 1505(j) (j=1 to M) may calculate phase differences using phases modified by the phase modification unit 4102(j.) (j=1 to M), as in Embodiment 2.

The phase modification unit 4102(j) (j=1 to M) modifies, to the phases according to the expression ψ″(t)=mod 2π(ψ(t)−2πf′t) (f′ is a frequency in a frequency band), phases of frequency signals obtained by subtracting frequency signals determined by the noise determination unit 1505(j) (j=1 to M) from the frequency signals, in a frequency band j (j=1 to M), determined by the DFT analysis unit 1100, in each of the predetermined directions set by the time axis adjustment unit 103, when the phase of a frequency signal at a time point t is ψ(t) (radian). This example differs from Embodiment 2 in the point of modifying the phase ψ(t) using a frequency f′ in the frequency band in which frequency signals have been determined, instead of modifying the phase ψ(t) using a reference frequency.

First, the to-be-extracted sound determination unit 4103(j) (j=1 to M) (phase distance determination unit 4200(j) (j=1 to M)) determines a reference frequency suitable for each of the frequency signals, of mixed sounds 2401(n) (n=1, 2), at time points in the predetermined time width on the time axis adjusted by the time axis adjustment unit 103. Next, the to-be-extracted sound determination unit 4103(j) (j=1 to M) calculates phase distances of the respective frequency signals, using the phase ψ″(t) of the frequency signal modified by the phase modification unit 4102(j) (j=1 to M) for each of the predetermined directions set by the time axis adjustment unit 103, and determines, to be frequency signals of an engine sound, the frequency signals in the predetermined time width having a phase distance equal to or less than the second threshold value.

Next, the sound detection unit 4104(j) (j=1 to M) generates and outputs a to-be-extracted sound detection flag 4105 when the to-be-extracted sound determination unit 4103(j) (j=1 to M) determines that a frequency signal of the engine sound (to-be-extracted sound) in one of the mixed sounds 2401(n) (n=1, 2) is present at a frequency band in one of the predetermined directions set by the time axis adjustment unit 103.

Lastly, the presentation unit 4106 notifies the driver of the presence of an approaching vehicle when the to-be-extracted sound detection flag 4105 is inputted by the sound detection unit 4104(j) (j=1 to M).

Each processing unit performs these processes with time shifts in the predetermined time width.

Next, a description is given of operations performed by the vehicle detection device 4100 configured as described above.

The following describes processing performed on the j-th frequency band (the frequency within the frequency band is denoted as f′)

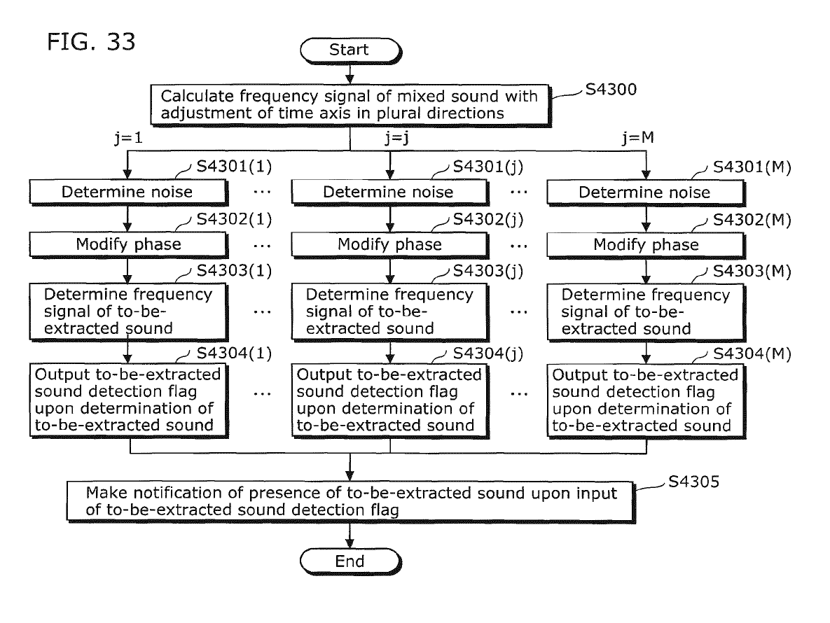

FIG. 33 is a flowchart showing a procedure of operations performed by a vehicle detection device 4100.

The DFT analysis unit 1100 receives mixed sounds 2401(n) (n=1, 2), and performs discrete Fourier transform thereon so as to determine frequency signals, of the mixed sounds 2401(n) (n=1, 2), which are at time points included in a predetermined time width on a time axis adjusted, by the time axis adjustment unit 103, such that the difference in the arrival time points of the mixed sounds arriving from predetermined directions is zero between the microphones. Here, plural directions are set as predetermined directions (Step S4300). In this example, the width of a window function used in the discrete Fourier transform is set to be 25 ms.

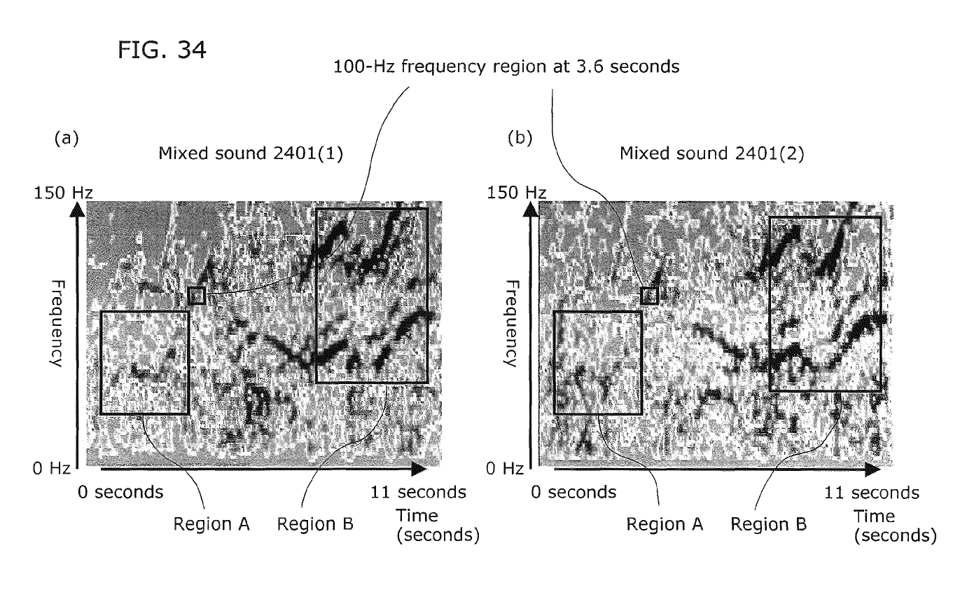

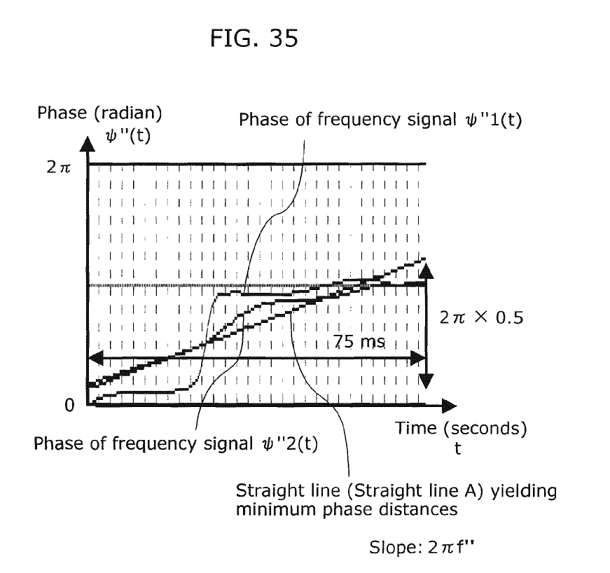

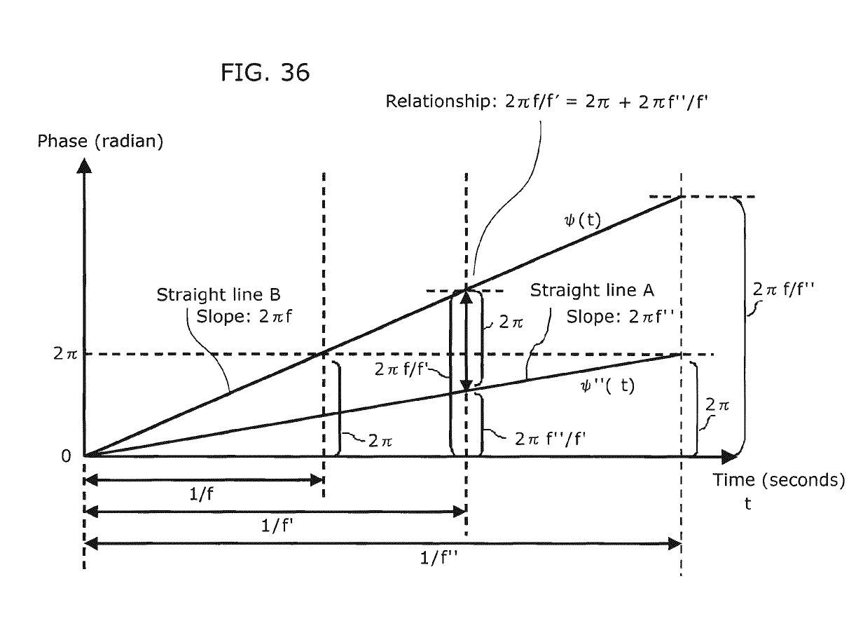

FIG. 34 is a diagram showing an exemplary spectrogram of a mixed sound 2401(1) and a mixed sound 2401(2). In each diagram, the horizontal axis is the time axis and the vertical axis is the frequency axis. The power of a frequency signal is represented using color contrast, and specifically, a dark color shows a frequency signal portion in which the power is great. In the presentation, the phase components of the frequency signal are not shown. FIGS. 34(a) and 34(b) are spectrograms of a mixed sound 2401(1) and a mixed sound 2401(2), respectively, and each of the mixed sounds 2401(1) and 2401(2) includes an engine sound and a wind noise. With reference to regions B in FIGS. 34(a) and 34(b), frequency signals of the engine sound are present in both the mixed sounds. In contrast, with reference to regions A in FIGS. 34(a) and 34(b), a frequency signal of the engine sound is present in the mixed sound 2401(1), but a frequency signal of the engine sound cannot be distinguished in the mixed sound 2401(2) due to an influence of the wind noise. The states of the mixed sounds are different between the microphones because the wind noise changes depending on the locations of microphones.

Next, among the frequency signals of the mixed sounds 2401(n) (n=1, 2) determined by the DFT analysis unit 1100, the noise determination unit 1505(j) determines frequency signals of a mixed sound having phase distances equal to or greater than the third threshold value from the phases of all the other frequency signals of the mixed sounds, at each of time points for which the time axis has been adjusted toward the predetermined direction (Step S4301(j)). In this example, the phase differences are calculated using the phases calculated by the DFT analysis unit 1100. This processing is performed with adjustment of the time axis for each of the directions as the predetermined directions set by the time axis adjustment unit 103.

In this example, the third threshold value is set to be 0.51 (radian). This processing is performed in the same manner as the method described in Embodiment 2.

Next, the phase modification unit 4102(j) (j=1 to M) modifies, to the phases according to the expression ψ″(t)=mod 2π(ψ(t)−2πf′t) (f′ is a frequency in a frequency band), phases of frequency signals obtained by subtracting frequency signals determined by the noise determination unit 1505(j) (j=1 to M) from the frequency signals, in a frequency band j (j=1 to M), determined by the DFT analysis unit 1100, in each of the predetermined directions set by the time axis adjustment unit 103, when the phase of a frequency signal at a time point t is ψ(t) (radian) (Step S4302). This example differs from Embodiment 2 in the point of modifying the phase ψ(t) using a frequency f′ in the frequency band in which frequency signals have been determined, instead of modifying the phase ψ(t) using a reference frequency f. The other conditions are the same as in Embodiment 2, and thus no description thereof is repeated.

Next, the to-be-extracted sound determination unit 4103(j) (phase distance determination unit 4200(j)) sets a reference frequency f, using the phases ψ″(t) of the frequency signals having phases modified by the phase modification unit 4102(j) (j=1 to M) at all the time points in the predetermined time width on the time axis adjusted by the time axis adjustment unit 103, for each of the frequency signals in each of the mixed sounds 2401(n) (n=1, 2). Here, the number of frequency signals is equal to or greater than a first threshold value corresponding to 50 percent of the number of the frequency signals at the time points in the predetermined time width. Subsequently, the to-be-extracted sound determination unit 4103(j) determines, to be frequency signals of the engine sound, the frequency signals in the predetermined time width having a phase distance equal to or less than the second threshold value (Step S4303(j)).

A description is given of a method, in FIGS. 34(a) and 34(b), of setting a suitable reference frequency f in the time-frequency domain of a 100-Hz frequency band having a predetermined time width (the time length has been set to be 75 ms) at the 3.6-second time point on the time axis adjusted by the time axis adjustment unit 103.

FIG. 35 shows the phases ψ″n(t) (n=1, 2), of the mixed sound in FIG. 34, which have been modified using a frequency f′ in a frequency band in the time-frequency domain of the 100-Hz frequency band having the predetermined time width (75 ms) at the 3.6-second time point on the time axis adjusted by the time axis adjustment unit 103. The horizontal axis is the time axis, and the vertical axis represents the phases ψ″n(t) (ψ″1(t) and ψ″2(t)). In this example, the phases have been modified using the frequency (f′=100 Hz) of the frequency band according to an expression ψ″n(t)=mod 2π(ψn(t)−2π×100×t) (n=1, 2). In addition, FIG. 35 shows a straight line (straight line A) that yields a minimum distance (phase distance) between each of these modified phases ψ″n(t) (n=1, 2) and the straight line defined in the space of time and phases ψ″(t).

The straight line can be determined by linear regression analysis. More specifically, the modified phase ψ″(t(i)) is converted into a response variable assuming that the time point t(i) is an explanatory variable (here, i (i=1 to N) is an index at the time when t is discrete).

As indicated below, the straight line A can be generated using, as 2K items of data, the modified phases ψ″n(t(i)) (n=1, 2 and i=1 to K) at each time point in the time-frequency domain, at 3.6-second time point, of the 100-Hz frequency band having the predetermined time width (75 ms).

φ″(t)=S_{tφ″}/S₁₁(t− t̅)+ φ̅″ [Expression 31]

Here, the following shows an average time point.

t̅=1/2KΣₙ₌₁ⁿ⁼²Σᵢ₌₁^{i=K}t(i) [Expression 32]

The following shows an average modified phase.

φ̅″=1/2KΣₙ₌₁ⁿ⁼²Σᵢ₌₁^{i=K}φ″ₙ(t(i)) [Expression 33]

The following shows a time point variance.

S₁₁=1/2KΣₙ₌₁ⁿ⁼²Σᵢ₌₁^{i=K}t(i)²− t̅² [Expression 34]

The following shows a covariance between a time point and a modified phase.

S^{tφ″}=1/2KΣₙ₌₁ⁿ⁼²Σᵢ₌₁^{i=K}t(i)φ″(t(i))− t̅ φ̅″ [Expression 35]

Here, with reference to FIG. 36, it is shown that a reference frequency f can be determined based on the slope of the straight line A in FIG. 35. Here, it is assumed that the slope of the straight line A shows that the phase ψ″(t) increments from 0 to 2π (radian) at each 1/f″ time interval. In short, the straight line A has a slope of 2πf″.

The straight line A in FIG. 36 is the same as the straight line A in FIG. 35. The horizontal axis in FIG. 36 is the time axis, and the vertical axis is the phase axis. The straight line (straight line B) defined by time and phases ψ(t) in FIG. 36 is a straight line defined by time and phases ψ(t) of the straight line A representing the phases that have not yet been modified using the frequency f′ (the frequency in the frequency band). In other word, the straight line B is calculated by adding 2π (radian) each time a current time point advances by 1/f′ with respect to the straight line A. This straight line B can be regarded to represent the phases ψ(t) of a to-be-extracted sound in the case where the to-be-extracted sound is present in the time-frequency domain, and the current phase ψ(t) shifts from 0 to 2π (radian) at a 1/f (f denotes a reference frequency) time interval at an equal angle speed. The frequency f corresponding to the slope (2πf) of the straight line B is the reference frequency f desired. In this example, the frequency f′ is smaller than the reference frequency f, and thus the straight line A has a positive slope. In the case where the frequency f′ in the frequency band equals to the reference frequency f, the straight line A has a zero slope, whereas the straight line A has a negative slope in the case where the frequency f′ is higher than the reference frequency f.

Based on the relationship between the straight lines A and B in FIG. 36, the following is derived.

2π(f′/f′)=2π+2π(f″/f′) [Expression 36]

This derives the following.

f=(f′+f″) [Expression 38]

More specifically, this shows that the reference frequency f can be presented as a sum of the frequency f′ in the frequency band and the frequency f″ corresponding to the slope (2π″) of the straight line A.

The time required for the modified phase ψ″(t) to increment from 0 (radian) to 2π (radian) is 0.075/0.5 (=1/f″ (seconds)). Thus the straight line A in FIG. 35 is presented as f″=6.7 (Hz), and the reference frequency f is 106.7 Hz (100 Hz+6.7 Hz).

Next, the phase distance (ψ′(t)=mod 2π(ψ(t)−2πft) (here, f denotes a reference frequency)) is calculated using the set reference frequency f. The phase distance can be calculated based on the distance between the phase ψ″(t) modified as shown in FIG. 35 and the straight line A.

This is because the distance (phase distance) between the phase ψ(t) and the straight line B having a slope of 2πf matches the distance between the phase ψ″(t) and the straight line A having a slope of 2πf″ as shown by the following expression.

$$\begin{matrix}{ϕ}^{′} ( t ) = mod 2 π ( ϕ ( t ) - 2 π f t ) \\ = mod 2 π ( ϕ ( t ) - 2 π ( {f}^{′} + {f}^{″} ) t ) \\ = mod 2 π ( ( ϕ ( t ) - 2 π {f}^{′} t ) - 2 π {f}^{″} t ) \\ = mod 2 π ( {ϕ}^{″} ( t ) - 2 π {f}^{″} t )\end{matrix} \qquad [ Expression 38 ]$$

In this example, the phase distances are calculated as difference errors between the straight line A and the respective phases ψ″(t) of the frequency signals having modified phases at all the time points in the predetermined time width.

It is also good to calculate a phase distance considering that the phase values are in a torus (that is, 0 (radian) and 2π (radian) are the same).

From another view point, the straight line A that yields the minimum phase distances is determined. This shows that the reference frequency f determined based on the frequency f″ corresponding to the slope of the straight line A is the reference frequency f that is suitable in the time-frequency domain to minimize the phase distances.

Subsequently, the to-be-extracted sound determination unit 4103(j) determines, to be frequency signals of the engine sound, the frequency signals in the predetermined time width having a phase distance equal to or less than the second threshold value. In this example, the third threshold value is set to be 0.34 (radian). In this example, the whole frequency signal in the predetermined time width is used to calculate a phase distance, and determinations are collectively made on the frequency signals at the respective time segments of the to-be-extracted sound.

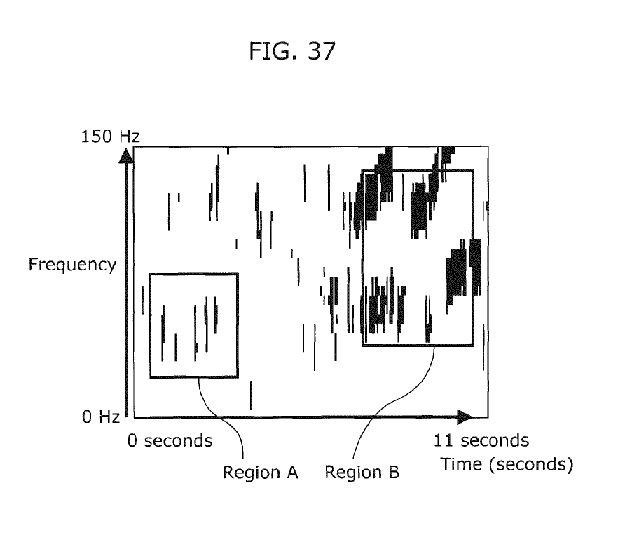

FIG. 37 is a diagram showing an example of a result of determining frequency signals of an engine sound in plural directions set by the time axis adjustment unit 103. This shows a result of determining frequency signals of the engine sound from the mixed sound shown in FIG. 34, and the time-frequency portions determined to be frequency signals of the engine sound in one of the directions set by the time axis adjustment unit 103 are presented in black. In each diagram, the horizontal axis is the time axis and the vertical axis is the frequency axis. The regions A and B in FIG. 34 correspond to the regions A and B in FIG. 37, respectively. With reference to the region A in FIG. 37, it is known that combining the frequency signals of both the mixed sounds 2401(n) (n=1, 2) makes it possible to accurately determine frequency signals of the engine sound in the mixed sounds.

These processes are performed on all the frequency bands j (j=1 to M).

Next, the sound detection unit 4104(j) generates and outputs a to-be-extracted sound detection flag 4105 at the time when the to-be-extracted sound determination unit 4103(j) determines that a frequency signal of the engine sound is present in at least one of the frequency bands (Step S4304(j)). In this example, the sound detection unit 4104(j) determines whether or not to generate and output a to-be-extracted sound detection flag 4105 each time of the is predetermined time width (75 ms) that is a unit of time for phase distance calculation, using all the results of determinations on the 10- to 150-Hz frequency band in which the engine sound of the motorbike is present.

Other methods of generating a to-be-extracted sound detection flag 4105 include a method of determining whether or not to generate and output a to-be-extracted sound detection flag 4105 at each of the time points set independently from the predetermined time width that is a unit of time for phase distance calculation. For example, in the case where a time interval (for example, 1 second) longer than the predetermined time width is used to determine whether or not to generate and output a to-be-extracted sound detection flag 4105, it is possible to steadily generate and output a to-be-extracted sound detection flag 4105 even when a frequency signal of the engine sound cannot be detected at some time points due to the influence of noises. In this way, it is possible to accurately perform vehicle detection.

Lastly, the presentation unit 4106 notifies a driver of the presence of the approaching vehicle upon input of the to-be-extracted sound detection flag 4105 (Step S4305).

Each processing unit performs these processes with time shifts in the predetermined time width.

The sound determination device is configured to remove noises represented by the frequency signals having a phase difference, of the mixed sounds, equal to or greater than the third threshold value between microphones, and determine frequency signals of a to-be-extracted sound without the noises. Therefore, the sound determination device is capable of performing an accurate determination using the first threshold value, and performing an accurate determination of the to-be-extracted sound. For example, wind noises received through the respective microphones have different phases, and thus they can be removed using the third threshold value. In addition, in the case of the sounds that are present in the direction other than the predetermined direction and received through the respective microphones, the frequency signals, between the microphones, which have phases adjusted in the time axis with respect to the predetermined direction have a great phase difference. Therefore, it is possible to remove noises using the third threshold value.

In addition, removing frequency signals, of the mixed sound, which yield a phase difference equal to or greater than the third threshold value from all the other frequency signals of the mixed sounds makes it possible to determine frequency signals of the to-be-extracted sounds without removing the frequency signals which may represent the to-be-extracted sounds. For example, in the case where noises such as wind noises are received through one of the microphones independently, removing all the frequency signals other than the frequency signals having similar phase differences between all the microphones inevitably removes all the frequency signals even when a to-be-extracted sound is received through the other microphone(s).

In addition, since a reference frequency suitable for determining a to-be-extracted sound can be determined in advance for each time-frequency domain basis, there is no need to calculate phase distances of a number of reference frequencies before determining the to-be-extracted sound. This significantly reduces the processing amount required for phase distance calculation.

In addition, the use of fine reference frequencies makes it possible to determine fine frequency signals of the to-be-extracted sound in mixed sounds in the determination of frequency signals of the to-be-extracted sound.

Furthermore, even when a microphone cannot detect a to-be-extracted sound from a received mixed sound due to an influence of noises, another microphone can detect the to-be-extracted sound in many cases. For this reason, the number of detection errors can be reduced. In this example, it is possible to use such mixed sound that is less affected by a wind noise because the mixed sound has been received through a microphone disposed to reduce the influence. For this, it is possible to accurately detect an engine sound as a to-be-extracted sound, and notify a driver of the presence of an approaching vehicle. The number of microphones used in this example is two, but three or more microphones may be used to determine frequency signals of a to-be-extracted sound.

Whether or not the respective whole frequency signals are frequency signals of the to-be-extracted sound is determined altogether by calculating the phase distances of the plural frequency signals altogether, and comparing each of the phase distances with the second threshold value. For this, it is possible to steadily determine frequency signals of a to-be-extracted sound even when the phase of a noise accidentally matches the phase of the to-be-extracted sound.

It should be noted that the to-be-extracted sound determination unit in one of Embodiments 1 and 2 may be used in the vehicle detection device according to Embodiment 3.

Alternatively, vehicle detection is performed without using any noise determination unit, as in Embodiment 1.

### Variation of Embodiment 3

Next, a description is given of a vehicle detection device according to Embodiment 3. The vehicle detection device determines that a frequency signal of an engine sound (to-be-extracted sound) is present nearby, and outputs the direction of the to-be-extracted sound to notify a driver of the direction in which an approaching vehicle is present nearby. The difference from Embodiment 3 lies in that the sound detection unit 4104(j) (j=1 to M) is replaced with the direction detection unit 5501(j) (j=1 to M).

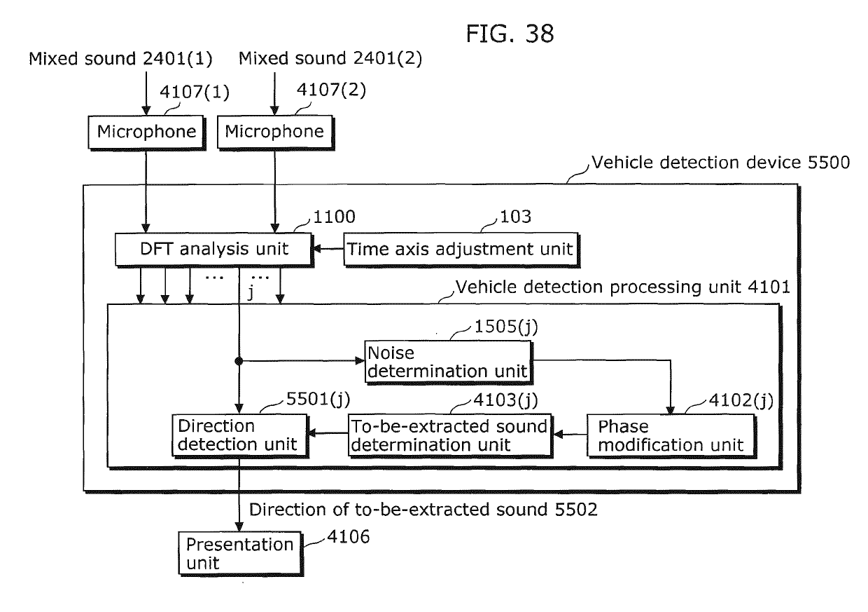

FIG. 38 is a block diagram showing the structure of the vehicle detection device according to a variation of Embodiment 3 in the present invention.

In FIG. 38, the vehicle detection device 5500 includes: a microphone 4107(1); a microphone 4107(2); a time axis adjustment unit 103; a DFT analysis unit 1100 (frequency analysis unit); a vehicle detection processing unit 4101 including a noise determination unit 1505(j) (j=1 to M); a phase modification unit 4102(j) (j=1 to M), a to-be-extracted sound determination unit 4103(j) (j=1 to M), and a direction detection unit 5501(j) (j=1 to M); and a presentation unit 4106.

The direction detection unit 5501(j) (j=1 to M) outputs, to the presentation unit 4106, information indicating the direction yielding the minimum phase distances as information indicating the direction 5502 of a to-be-extracted sound, from among the predetermined directions in which frequency signals of the to-be-extracted sound are determined by the to-be-extracted sound determination unit 4103(j) (j=1 to M).

The following describes processing performed by the vehicle detection device 5500 configured as described above. The following describes a j-th frequency band (the frequency within the frequency band is denoted as f′).

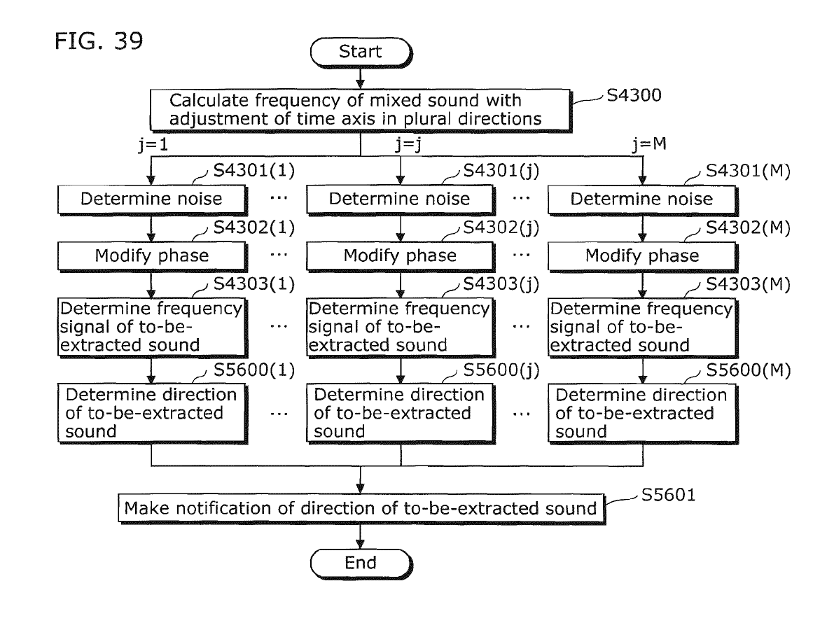

FIG. 39 is a flowchart showing a procedure of operations performed by a vehicle detection device 5500.

The DFT analysis unit 1100 receives mixed sounds 2401(n) (n=1, 2), and performs discrete Fourier transform thereon so as to determine frequency signals, of the mixed sounds 2401(n) (n=1, 2), which are at time points included in a predetermined time width on a time axis adjusted, by the time axis adjustment unit 103, such that the difference in the arrival time points of the mixed sounds arriving from predetermined directions is zero between the microphones. Here, plural directions are set as predetermined directions (Step S4300). This processing is performed in the same manner as in Embodiment 3.

Next, among the frequency signals of the mixed sounds 2401(n) (n=1, 2) determined by the DFT analysis unit 1100, the noise determination unit 1505(j) determines frequency signals of a mixed sound having phase distances equal to or greater than the third threshold value from the phases of all the other frequency signals of the mixed sounds, at each of time points for which the time axis has been adjusted toward the predetermined direction (Step S4301(j)). This processing is performed in the same manner as in Embodiment 3.

Next, the phase modification unit 4102(j) (j=1 to M) modifies, to the phases according to the expression ψ″(t)=mod 2π(ψ(t)−2πf′t) (f′ is a frequency in a frequency band), phases of frequency signals obtained by subtracting frequency signals determined by the noise determination unit 1505(j) (j=1 to M) from the frequency signals, in a frequency band j (j=1 to M), determined by the DFT analysis unit 1100, in each of the predetermined directions set by the time axis adjustment unit 103, when the phase of a frequency signal at a time point t is ψ(t) (radian). This processing is performed in the same manner as in Embodiment 3.

Next, the to-be-extracted sound determination unit 4103(j) (phase distance determination unit 4200(j)) sets a reference frequency f, using the phases ψ″(t) of the frequency signals having phases modified by the phase modification unit 4102(j) (j=1 to M) at all the time points in the predetermined time width on the time axis adjusted by the time axis adjustment unit 103, for each of the frequency signals in each of the mixed sounds 2401(n) (n=1, 2). Here, the number of frequency signals is equal to or greater than a first threshold value corresponding to 50 percent of the number of the frequency signals at the time points in the predetermined time width. Subsequently, the to-be-extracted sound determination unit 4103(j) determines, to be frequency signals of the engine sound, the frequency signals in the predetermined time width having a phase distance equal to or less than the second threshold value (Step S4303(j)). This processing is performed in the same manner as in Embodiment 3.

Next, the direction detection unit 5501(j) outputs, to the presentation unit 4106, the information indicating the direction yielding the minimum phase distances as the information indicating the direction 5502 of a to-be-extracted sound, from among the predetermined directions in which frequency signals of the to-be-extracted sound are determined by the to-be-extracted sound determination unit 4103(j) (Step S5600(j)).

Here, a direction determined to be of frequency signals of a to-be-extracted sound is determined from among the plural directions set as the predetermined directions by the time axis adjustment unit 103. In the case where no frequency signal of the to-be-extracted sound is present in any one of the directions, the information indicating the direction 5502 of the to-be-extracted sound is not outputted due to the absence of the to-be-extracted sound. In the case where a frequency signal of the to-be-extracted sound is present in only a single direction, the information indicating the direction 5502 as the direction of the to-be-extracted sound is outputted. In the case where a frequency signal of the to-be-extracted sound is present in plural directions, the information indicating the direction of the to-be-extracted sound yielding the minimum phase distance in determination of frequency signals of the to-be-extracted sound is outputted as the information indicating the direction 5502.

It is to be noted that, in the case where a frequency signal of the to-be-extracted sound is present in plural directions, information indicating all the directions of the to-be-extracted sound is outputted as information indicating the directions 5502. In this case, it is possible to output information indicating each of the sound source directions of the to-be-extracted sounds present in the plural directions. In particular, the direction detection device is capable of outputting information indicating the sound source directions of the respective to-be-extracted sounds even when different kinds of to-be-extracted sounds (for example, a voice of Person A and a voice of Person B) are inputted in different directions.

Lastly, the presentation unit 4106 notifies a driver of the direction of the approaching vehicle upon input of information indicating the direction 5502 of the to-be-extracted sound (Step S5601).

Each processing unit performs these processes with time shifts in the predetermined time width.

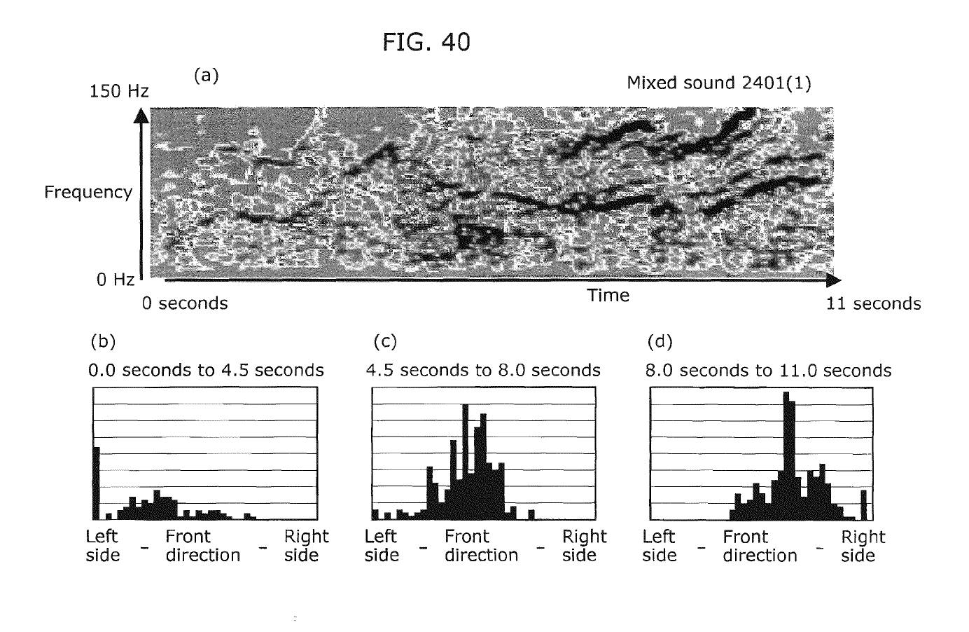

FIG. 40 is a diagram showing experimental results of detecting the direction in which the vehicle was approaching. The experimental conditions are the same as in Embodiment 3, and the mixed sounds 2401(1) and 2401(2) shown in FIG. 34 are used. These results correspond to the vehicle detection results, shown in FIG. 37, obtained as to the sound source directions of the vehicle.

FIG. 40(a) is the same as FIG. 34(a). Each of FIGS. 40(b), 40(c), and 40(d) shows the numbers of times of appearance of directions (directions 5502 of the to-be-extracted sound) detected at 10- to 150-Hz in each of time segments. The horizontal axis represents direction. FIG. 40(b) shows the number of times of appearance of the directions in the 0.0- to 4.5-second time segment. FIG. 40(c) shows the number of times of appearance of the directions in the 4.5- to 8.0-second time segment. FIG. 40(d) shows the number of times of appearance of the directions in the 8.0- to 11.0-second time segment. FIGS. 40(b), 40(c), and 40(d) show that the vehicle was approaching from the left side (see FIG. 40(b)), and was passing through in the front (see FIG. 40(c)) and then to the right side (see FIG. 40(d)), respectively: For example, it is also good to present the driver with the gravity-center directions in the distribution of the number of times of appearance of the directions.

The direction determination device configured in this manner outputs information indicating the direction that yields the minimum phase distances to be the sound source direction of the to-be-extracted sound, and thus is capable of accurately outputting the sound source direction of the to-be-extracted sound inputted in a single direction.

Next, a description is given of an exemplary arrangement of plural microphones. The following describes a case of attaching the microphones to a vehicle.

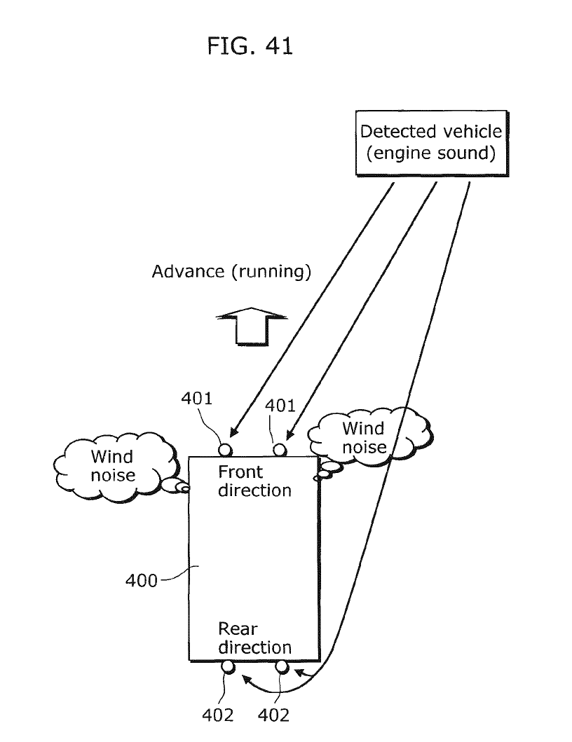

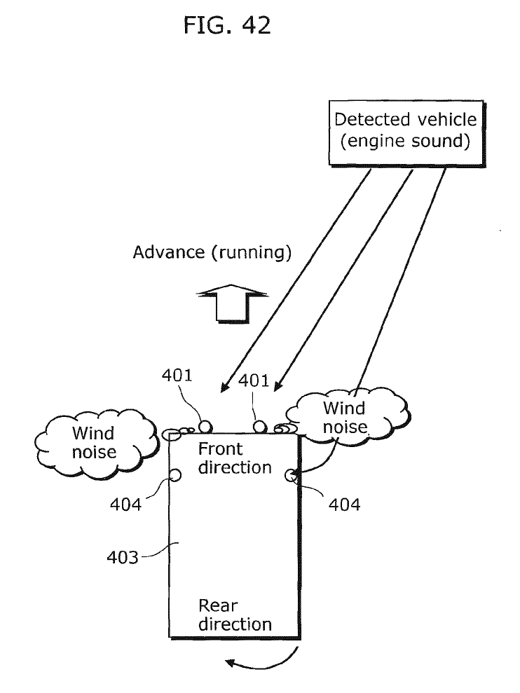

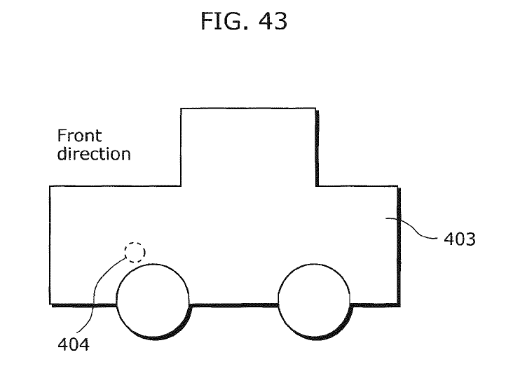

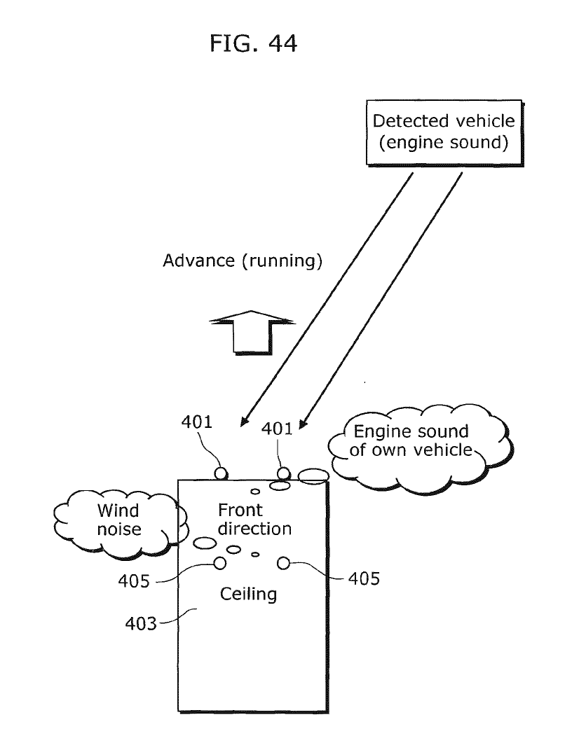

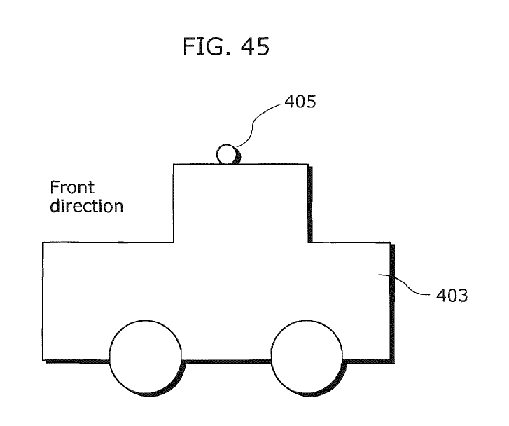

FIG. 41 is a diagram showing a first exemplary arrangement of plural microphones. FIG. 41 is a schematic top view of the vehicle.

As shown in FIG. 41, two microphones 401 are attached to the front bumper of a vehicle 403, and two microphones 402 are attached to the back bumper of the vehicle 403. In this case, it is assumed that a vehicle to be detected is in front of the vehicle 403 that is running.

Since the vehicle 403 is moving forward, a wind noise is likely to be received through the microphones 401, and is less likely to be received through the microphones 402. The direction of a running sound of the to-be-detected vehicle is easy to detect for the microphones 401 based on the difference in the arrival time points at the respective microphones 401 because the running sound arrives directly via air. In contrast, error arises when the direction is detected by the microphones 402 based only on the difference in the arrival time points at the respective microphones 402 due to the influence of the body of the vehicle 403 placed on the arrival time points of the running sounds.

In other words, the accuracy in extracting the engine sound of the to-be-detected vehicle is poor when only the microphones 401 are used, and the accuracy in extracting the direction of the to-be-detected vehicle is poor when only the microphones 402 are used. For these reasons, it is necessary to use the microphones 401 and the microphones 402 in combination.

The use of the phases of the engine sound, of the to-be-detected vehicle, received through the microphones 402 less affected by the wind noise makes it possible to extract the engine sound, of the to-be-detected vehicle, which cannot be fully received through the microphones 401. In addition, the use of the microphones 401 which can detect, with high accuracy, the direction of the to-be-extracted engine sound of the to-be-detected vehicle makes it possible to accurately determine the direction of the to-be-detected vehicle.

Each of FIGS. 42 and 43 is a diagram showing a second exemplary arrangement of plural microphones. FIG. 42 is a schematic top view of the vehicle, and FIG. 43 is a schematic side view of the vehicle.

FIGS. 42 and 43 show that two microphones 401 are attached to the front bumper of the vehicle 403, and that two microphones 404 are attached to the portions near the tires (for example, near the mudguards) of the vehicle. In this case, a vehicle to be detected is assumed to be in front of the vehicle 403.

Since the vehicle 403 is running, a wind noise is likely to be input through the microphones 401, but is less likely to be input through the microphones 404 attached to positions at which noises are blocked by the car body. The direction of a running sound of the to-be-detected vehicle received through the microphones 401 and detected based on the difference in the arrival time points at the respective microphones 401 is accurate because the running sound arrives directly via air. In contrast, the direction of a running sound of the to-be-detected vehicle received through the microphones 401 and detected based on the difference in the arrival time points at the respective microphones 404 is erroneous because the arrival time points of the running sound are affected by the body of the vehicle 403.

In other words, the accuracy in extracting the engine sound of the to-be-detected vehicle is poor when only the microphones 401 are used, and the accuracy in extracting the direction of the to-be-detected vehicle is poor when only the microphones 404 are used. For these reasons, it is necessary to use the microphones 401 and the microphones 404 in combination.

The use of the phases of the engine sound, of the to-be-detected vehicle, received through the microphones 404 less affected by the wind noise makes it possible to extract the engine sound, of the to-be-detected vehicle, which cannot be fully received through the microphones 401. In addition, the use of the microphones 401 which can detect, with high accuracy, the direction of the to-be-extracted engine sound of the to-be-detected vehicle makes it possible to accurately determine the direction of the to-be-detected vehicle.

Each of FIGS. 44 and 45 is a diagram showing a third exemplary arrangement of plural microphones. FIG. 44 is a schematic top view of the vehicle, and FIG. 45 is a schematic side view of the vehicle.

FIGS. 44 and 45 show that two microphones 401 are attached to the front bumper of the vehicle 403, and that two microphones 405 are attached to the ceiling of the vehicle 403. In this case, it is assumed that a vehicle to be detected is assumed to be in front of the vehicle 403 that is running.

The engine sound of the vehicle itself is likely to be received through the microphones 401, but is less likely to be received through the microphones 405 positioned distant from the engine room. In contrast, the microphones 405 are less likely to receive a wind noise than the microphones 401 do. At this time, since the engine sound of the vehicle itself and the wind noise are different kinds of noises, the mixed-in timings thereof are different.

Determining phases using the microphones 401 less affected by the wind noise and the microphones 405 less affected by the engine sound of the vehicle itself makes it possible to accurately extract the engine sound of a to-be-detected vehicle. Thus, it is also possible to accurately detect the direction of the to-be-detected vehicle.

The noise removal device and vehicle detection device described in the above embodiments may be implemented by causing CPUs of computers to execute the programs for implementing the functions of the respective processing units of the respective devices. In this case, data to be processed by the respective processing units are stored in memory or hard discs in the computers.

Although the embodiments are described as examples for only illustrative purposes in all respects, the present invention should be understood as not being limited to these embodiments. Thus, the scope of the present invention is indicated by not the embodiments but the Claims. Those skilled in the art will readily appreciate that many modifications and variations are possible in the exemplary embodiments without materially departing from the novel teachings and advantages of the present invention. Accordingly, all such modifications and variations having meanings equivalent to those in the present invention are intended to be included within the scope of the present invention.

### INDUSTRIAL APPLICABILITY

A sound determination device and the like according to the present invention is capable of determining frequency signals of a to-be-extracted sound included in a mixed sound, on a per time-frequency domain basis. In particular, the present invention allows determination of frequency signals of the to-be-extracted sounds in distinction from noises in the case where the to-be-extracted sounds and noises are present in the same direction. In addition, the present invention has an object to provide a sound determination device which separates toned sounds such as an engine sound, a siren sound, and a voice, in distinction from toneless sounds such as a wind noise, a rain sound, and a background noise, and determines frequency signals of a toned sound (or a toneless sound) on a per time-frequency domain basis.

For this, the present invention can be applied to an audio output device which receives inputs of audio frequency signals determined on a per time-frequency domain basis, and output the extracted sound using an inverse frequency transform. In addition, the present invention can be applied to an audio source direction detection device which receives, for a to-be-extracted sound in each of mixed sounds received through at least two microphones, input audio frequency signals determined on a per time-frequency basis, and outputs information indicating the audio source direction of the to-be-extracted sound. Further, the present invention can be applied to a sound identification device which receives input frequency signals, of a to-be extracted sound, determined on a per time-frequency domain basis, and performs voice recognition and sound identification. Furthermore, the present invention can be applied to a wind noise level determination device which receives input frequency signals, of a wind noise, determined on a per time-frequency domain basis, and output information indicating the magnitude of the signal power. In addition, the present invention can be applied to a vehicle detection device which receives input audio frequency signals, of a running noise due to friction of tires, determined on a per time-frequency domain basis, and detect a vehicle based on the signal power. Further, the present invention can be applied to a vehicle detection device which detects frequency signals, of an engine sound, determined on a per time-frequency domain basis, and notify a driver of the presence of an approaching vehicle. Furthermore, the present invention can be applied to an emergency vehicle detection device to which detects frequency signals, of a siren sound, determined on a per time-frequency domain basis, and notify a driver of the presence of an approaching emergency vehicle.

What is claimed is:

1. A sound determination device comprising:
a time axis adjustment unit configured to receive mixed sounds each of which includes a to-be-extracted sound and a noise through a corresponding one of a plurality of microphones, and adjust time axes of the mixed sounds such that a difference in arrival time points at which the mixed sounds from predetermined directions arrive at the plurality of respective microphones is zero;
a frequency analysis unit configured to determine frequency signals of the mixed sounds, each of the frequency signals being at a corresponding one of predetermined time points in a predetermined time width on the time axes adjusted by said time axis adjustment is unit; and
a to-be-extracted sound determination unit configured to determine, for each of all the sounds to be extracted, frequency signals satisfying conditions of (i) being equal to or greater than a first threshold value in number and (ii) having a phase distance between the frequency signals that is equal to or smaller than a second threshold value, the condition-satisfying frequency signals being included in the frequency signals of the mixed sounds at the time points in the predetermined time width, and being determined by said frequency analysis unit,
wherein the phase distance is a distance between phases of the condition-satisfying frequency signals when a phase of a frequency signal at a current time point t among the time points is ψ(t) (radian) and the phase ψ′(t) is expressed by an expression ψ′(t)=mod 2π(ψ(t)−2πft)=ψ(t), f denoting a reference frequency.

2. The sound determination device according to claim 1, further comprising
a noise determination unit configured to determine, from among the frequency signals determined by said frequency analysis unit, frequency signals having a phase difference from all other frequency signals in the mixed sound that is equal to or greater than a third threshold value, each of the frequency signals being at a corresponding one of the predetermined time points on the time axes adjusted by said time axis adjustment unit,
wherein said to-be-extracted sound determination unit is configured to determine, to be frequency signals of the to-be-extracted sound, frequency signals satisfying the conditions of (i) being equal to or greater than the first threshold value in number and (ii) having the phase distance between the frequency signals that is equal to or smaller than the second threshold value, from among frequency signals obtained by subtracting the frequency signals determined by said noise determination unit from the frequency signals of the mixed sounds, the frequency signals being at the time Is points included in the predetermined time width, and being determined by said frequency analysis unit.

3. The sound determination device according to claim 1,
wherein said time axis adjustment unit is configured to set plural directions as the predetermined directions, and adjust the time axes of the mixed sounds in each of the set directions,
said frequency analysis unit is configured to determine frequency signals of the mixed sounds included in the predetermined time width on the time axes adjusted in each of the set directions, and
said to-be-extracted sound determination unit is configured to determine frequency signals of the to-be-extracted sound, from among the frequency signals of the mixed sounds, the frequency signals being included in the predetermined time width on the time axes adjusted in each of the set directions.

4. A sound detection device comprising:
the sound determination device according to claim 1; and
a sound detection unit configured to generate and output a to-be-extracted sound detection flag when said sound determination device determines that a frequency signal among the frequency signals of the mixed sounds is a frequency signal of one of the sounds to be extracted.

5. A sound extraction device comprising:
the sound determination device according to claim 1; and
a sound extraction unit configured to output a frequency signal among the frequency signals of the mixed sound when said sound determination device determines that the frequency signal is a frequency signal of one of the sounds to be extracted.

6. A direction detection device comprising:
the sound determination device according to claim 3; and
a direction detection unit configured to output, to be a sound source direction, information indicating the predetermined direction in which frequency signals of the to-be-extracted sound are determined in one of the mixed sounds.

7. The direction detection device according to claim 6,
wherein said direction detection device is configured to output, to be a sound source direction, information indicating a direction yielding a minimum phase distance, from among the predetermined directions in which the frequency signals of the to-be-extracted sound are determined in one of the mixed sounds.

8. A sound determination method comprising:
receiving mixed sounds each of which includes a to-be-extracted sound and a noise through a corresponding one of plurality of microphones, and adjusting time axes of the mixed sounds such that a difference in arrival time points at which the mixed sounds from predetermined directions arrive at the plurality of respective microphones is zero;
determining frequency signals of the mixed sounds, each of the frequency signals being at a corresponding one of predetermined time points in a predetermined time width on the time axes adjusted in said adjusting; and
determining, for each of all the sounds to be extracted, frequency signals satisfying conditions of (i) being equal to or greater than a first threshold value in number and (ii) having a phase distance between the frequency signals that is equal to or smaller than a second threshold value, the condition-satisfying frequency signals being included in the frequency signals of the mixed sounds at the time points in the predetermined time width, and being determined in said determining of frequency signals of the mixed sounds, wherein the phase distance is a distance between phases of the condition-satisfying frequency signals when a phase of a frequency signal at a current time point t among the time points is ψ(t) (radian) and the phase ψ′(t) is expressed by an expression ψ′(t)=mod 2π(ψ(t)−2πft)=ψ(t), f denoting a reference frequency.

9. A sound determination program product which, when loaded into a computer, allows the computer to execute:
receiving mixed sounds each of which includes a to-be-extracted sound and a noise through a plurality of microphones, and adjusting time axes of the mixed sounds such that a difference in arrival time points at which the mixed sounds from predetermined directions arrive at the plurality of respective microphones is zero;
determining frequency signals of the mixed sounds, each of the frequency signals being at a corresponding one of predetermined time points in a predetermined time width on the time axes adjusted in the adjusting; and
determining, for each of all the sounds to be extracted, frequency signals satisfying conditions of (i) being equal to or greater than a first threshold value in number and (ii) having a phase distance between the frequency signals that is equal to or smaller than a second threshold value, the condition-satisfying frequency signals being included in the frequency signals of the mixed sounds at the time points in the predetermined time width, and being determined in the determining of frequency signals of the mixed sounds,
wherein the phase distance is a distance between phases of the condition-satisfying frequency signals when a phase of a frequency signal at a current time point t among the time points is ψ(t) (radian) and the phase ψ′(t) is expressed by an expression ψ′(t)=mod 2π(ψ(t)−2πft)=ψ(t), f denoting a reference frequency.
